(19) United States
(12) Patent Application Publication
(10) Pub. No.: US 2026/0254921 A1
(43) Pub. Date: Aug. 27, 2026

(54) MACHINE-LEARNING-BASED TELEMETRY-DRIVEN AUTONOMOUS MONITORING, CONTROL, AND OPTIMZATION OF CABLE NETWORKS

(71) Applicant: Broadband International Inc., Medley, FL (US)

(72) Inventors: Dogan Atlas, Atlanta, GA (US); Edward Perez, Atlanta, GA (US)

(73) Assignee: Broadband International Inc., Medley, FL (US)

(21) Appl. No.: 19/548,627

(22) Filed: Feb. 24, 2026

Related U.S. Application Data
(60) Provisional application No. 63/762,438, filed on Feb. 24, 2025.

(51) Int. Cl. H04N 7/10; H04L 5/00

(52) U.S. Cl. CPC H04N 7/102; H04L 5/0048

(57) ABSTRACT

Data signals transmitted over cable networks experience degradation, such as frequency-dependent loss, spectral tilt, signal-dependent nonlinear noise, distortion, and compression, which vary with cable characteristics, temperature, electrical loading, and traffic conditions. The present invention relates to improving network performance by estimating cable signal-degradation using physics-based nonlinear system modeling and telemetry data and applying corrections to operating parameters of cascading amplifiers to offset the signal degradation, thereby improving overall network efficiency and reliability.

### CROSS-REFERENCE TO RELATED APPLICATION

This application claims priority to U.S. Provisional Application 63/762,438, filed on Feb. 24, 2025, the contents of which are incorporated by reference in their entirety.

U.S. patent application Ser. No. 19/265,793 and U.S. patent application Ser. No. 19/336,004 are both also hereby incorporated by reference in their entirety.

### BACKGROUND

Cable television (CATV) networks is a form of broadcasting that transmits programs to subscriber locations through a physical land-based infrastructure of coaxial cables or through a combination of fiber-optic and coaxial cables. Some CATV systems have evolved into bidirectional hybrid fiber coaxial (HFC) networks that support broadband internet and interactive services. HFC networks rely on radio frequency (RF) amplifiers to extend signal reach across coaxial distribution lines to ensure adequate signal strength. The amplifiers can compensate for signal losses over long distances by amplifying both forward (downstream) and reverse (upstream) signals.

### BRIEF DESCRIPTION OF THE DRAWINGS

FIG. 1 a schematic drawing of a typical hybrid fiber/coaxial cable-based broadband/CATV telecommunications system, according to one or more embodiments.

FIG. 2 is a block diagram illustrating a system for cable network with HFC remote management, according to one or more embodiments.

FIG. 2A is an exemplary diagram of a frequency band with upstream and downstream pilot signals and telemetry signals.

FIG. 3 is a diagrammatic illustration of an HFC network, according to one or more embodiments.

FIG. 4 is an example schematic diagram of an amplifier of the system of FIG. 2, according to one or more embodiments.

FIG. 5 is an example schematic diagram of a telemetry and signal monitoring system used in the amplifiers of FIG. 2 or FIG. 4, according to one or more embodiments

FIG. 6A is a schematic diagram of a signal monitoring transponder of the amplifiers of FIG. 2 or FIG. 4, according to one or more embodiments.

FIG. 6B is a schematic diagram of a gateway controller, according to one or more embodiments.

FIG. 7 is diagrammatic illustration of a node gateway and network server, according to one or more embodiments.

FIG. 8 is an example flow diagram of a method for improving network performance according to one or more embodiments.

FIG. 9 is an example flow diagram of a method for improving network performance according to one or more embodiments.

FIG. 10 is an example flow diagram of a method for improving network performance according to one or more embodiments.

FIG. 11 is an example flow diagram of a method for improving network performance according to one or more embodiments.

FIG. 12 is an example flow diagram of a method for improving network performance using machine learning, according to one or more embodiments.

### SUMMARY

In an embodiment, a network system comprises a headend, a controller communicatively coupled to the headend via one or more communication links, and a first amplifier. The first amplifier is communicatively coupled to the controller and configured to: generate a set of pilot signals having known transmit levels; transmit the pilot signals upstream to the controller; receive telemetric feedback data, based on the pilot signals, downstream via the controller; and adjust operating parameters, based on the telemetric feedback data, to compensate for signal degradation occurring between the first amplifier and the controller.

The system may further comprise a second amplifier, communicatively coupled to the first amplifier, configured to: generate a set of pilot signals having known transmit levels; transmit the pilot signals upstream to one or more of the first amplifier and the controller; receive telemetric feedback data, based on the pilot signals, downstream via the first amplifier, and adjust operating parameters, based on the telemetric feedback data, to compensate for signal degradation occurring between the first amplifier and the node.

In some embodiments, the first amplifier may be configured to transmit pilot signal information, including the known transmit levels of the pilot signals, upstream to the controller. The telemetric feedback data may comprise instructions for the first amplifier to adjust its operating parameters to compensate for signal degradation occurring between the first amplifier and the node. The controller may be configured to generate the instructions based on a comparison of the pilot signal information and the pilot signals. The telemetric feedback data may include received pilot signal levels, and the first amplifier may be configured to compare the received pilot signal levels with the known transmit pilot signal levels, estimate signal degradation occurring between the first amplifier and the node, generate corrective instructions based on the estimated signal degradation, and apply the corrective instructions to compensate for the estimated signal degradation. The telemetric feedback data may be generated based on the output of a machine-learning model.

A method of improving performance of a network comprises: generating, by a first amplifier, a set of pilot signals and pilot signal information pertaining to the set of pilot signals, the pilot signal information including transmit levels of the pilot signals; transmitting, by the first amplifier, the set of pilot signals and the pilot signal information to a gateway controller; measuring, by the gateway controller, characteristics of the received pilot signals, the characteristics including received pilot signal levels; comparing, by the gateway controller, the measured characteristics with the pilot signal information; generating, by the gateway controller, based on the comparison of the measured characteristics with the pilot signal information, corrective instructions for the first amplifier; transmitting, by the gateway controller, the corrective instructions to the first amplifier; and applying, by the first amplifier, corrections in accordance with the corrective instructions.

The above method may further comprise: generating, by a second amplifier, a second set of pilot signals and second pilot signal information pertaining to the second set of pilot signals, the second pilot signal information including transmit levels of the second pilot signals; transmitting, by the second amplifier, the second set of pilot signals and the second pilot signal information upstream to the gateway controller; measuring, by the gateway controller, characteristics of the received second pilot signals, the characteristics including received second pilot signal levels; comparing, by the gateway controller, the measured characteristics of the second pilot signals with the second pilot signal information; generating, by the gateway controller, based on the comparison of the measured characteristics of the second pilot signals with the second pilot signal information, corrective instructions for the second amplifier; transmitting, by the gateway controller, the corrective instructions for the second amplifier downstream to the second amplifier; and applying, by the second amplifier, corrections in accordance with the corrective instructions for the second amplifier. The gateway controller may be co-located with a node.

Another method of improving performance of a network comprises: generating, by a first amplifier, a set of pilot signals and pilot signal information pertaining to the set of pilot signals, the pilot signal information including transmit levels of the pilot signals; transmitting, by the first amplifier, the set of pilot signals and the pilot signal information upstream to a node; measuring, by the node, characteristics of the received pilot signals, the characteristics including received pilot signal levels; comparing, by the node, the measured characteristics with the pilot signal information; converting, by the node, the measured characteristics and the pilot signal information into optical signals; transmitting, by the node, the optical signals upstream to a central controller; comparing by the central controller, the measured characteristics with the pilot signal information; generating, by the central controller, based on the comparison of the measured characteristics with the pilot signal information, corrective instructions for the first amplifier; transmitting, by the central controller, the corrective instructions downstream to the node; converting, by the node, the corrective instructions to RF signals; transmitting, by the node, the RF signals to the first amplifier; and applying, by the first amplifier, corrections in accordance with the corrective instructions.

The above method may further comprise: generating, by a second amplifier, a second set of pilot signals and second pilot signal information pertaining to the second set of pilot signals, the second pilot signal information including transmit levels of the second pilot signals; transmitting, by the second amplifier, the second set of pilot signals and the second pilot signal information upstream to the node; measuring, by the node, characteristics of the received second pilot signals, the characteristics including received second pilot signal levels; comparing, by the node, the measured characteristics of the received second pilot signals with the second pilot signal information; converting, by the node, the measured characteristics of the received second pilot signals and the second pilot signal information into second optical signals; transmitting, by the node, the second optical signals upstream to the central controller; comparing by the central controller, the measured characteristics of the received second pilot signals with the second pilot signal information; generating, by the central controller, based on the comparison of the measured characteristics of the received second pilot signals with the second pilot signal information, second corrective instructions for the second amplifier; transmitting, by the central controller, the second corrective instructions downstream to the node; converting, by the node, the second corrective instructions to second RF signals; transmitting, by the node, the second RF signals to the second amplifier; and applying, by the second amplifier, corrections in accordance with the second corrective instructions.

Another method of improving network performance comprises: generating, by a first amplifier, a set of pilot signals and pilot signal information pertaining to the set of pilot signals, the pilot signal information including transmit levels of the pilot signals; transmitting, by the first amplifier, the set of pilot signals upstream to a controller; measuring, by the controller, characteristics of the received pilot signals, the characteristics including received pilot signal levels; transmitting, by the controller, the measured characteristics downstream to the first amplifier; comparing, by the first amplifier, the measured characteristics with the pilot signal information; generating, by the first amplifier, corrective instructions based on the comparison of the measured characteristics with the pilot signal information; and applying, by the first amplifier, corrections in accordance with the corrective instructions. This method may further comprise sending, by the first amplifier, the pilot signal information upstream to the controller.

The above method may further comprise: generating, by a second amplifier, a second set of pilot signals and second pilot signal information pertaining to the second set of pilot signals, the second pilot signal information including transmit levels of the second pilot signals; transmitting, by the second amplifier, the second set of pilot signals upstream to the controller; measuring, by the controller, second characteristics of the received second pilot signals, the second characteristics including received second pilot signal levels; transmitting, by the controller, the second measured characteristics downstream to the second amplifier; comparing, by the second amplifier, the second measured characteristics with the second pilot signal information; generating, by the second amplifier, second corrective instructions based on the comparison of the second measured characteristics with the second pilot signal information; and applying, by the second amplifier, corrections in accordance with the second corrective instructions.

Another method of improving network performance comprises: generating, by a controller, a set of pilot signals and pilot signal information pertaining to the pilot signals; transmitting, by the controller to a downstream first amplifier, the set of pilot signals and pilot signal information; receiving, by the first amplifier, the pilot signal information and the pilot signals; measuring, by the first amplifier, characteristics of the pilot signals, including received pilot signal levels; determining, by one or more of the first amplifier, the controller, a gateway controller, a central controller, and a mobile compute device, downstream cable loss and tilt characteristics between the controller and the first amplifier, by comparing the pilot signal information with the measured characteristics of the pilot signals; estimating, by one or more of the first amplifier, the controller, the gateway controller, the central controller, and the mobile compute device, upstream cable loss and tilt characteristics based on the determined downstream cable loss and tilt characteristics; and applying, by the first amplifier, corrective operating parameters based on the estimated upstream cable loss and tilt characteristics. The controller may be a gateway controller. The controller may be an amplifier that is upstream of the first amplifier.

The above method may further comprise: generating, by the controller, a second set of pilot signals and second pilot signal information pertaining to the second pilot signals; transmitting, by the controller to a downstream second amplifier, the second set of pilot signals and second pilot signal information; receiving, by the second amplifier, the second pilot signal information and the second pilot signals; measuring, by the second amplifier, second characteristics of the second pilot signals, including received second pilot signal levels; determining, by one or more of the second amplifier, the controller, the gateway controller, the central controller, and the mobile compute device, second downstream cable loss and tilt characteristics between the controller and the second amplifier, by comparing the second pilot signal information with the second measured characteristics of the second pilot signals; estimating, by one or more of the second amplifier, the controller, the gateway controller, the central controller, and the mobile compute device, second upstream cable loss and tilt characteristics based on the determined second downstream cable loss and tilt characteristics; and applying, by the second amplifier, corrective operating parameters based on the estimated second upstream cable loss and tilt characteristics.

Another method of improving performance of a network comprises: collecting, from each of a node, a first amplifier, and a second amplifier, downstream (DS) telemetry data, upstream (US) telemetry data, and environmental data; generating synthetic DS telemetry data and US telemetry data using a nonlinear system model; training a machine-learning (ML) model, using the DS telemetry data, US telemetry data, and environmental data, and the synthetic DS telemetry data and US telemetry data, to perform at least one of: estimating nonlinear operating margins; predicting nonlinear noise growth; and optimizing operating points across cascaded amplifier stages; implementing the trained ML model in a controller; sending, by the controller to one or more of the node, the first amplifier, and the second amplifier, instructions to adjust operating parameters based on a predicted or detected change in conditions in the network; receiving updated DS and US telemetry data following the parameter adjustments and training the ML model using the updated telemetry data. The controller may be a central controller, a node, or a mobile compute device.

### DETAILED DESCRIPTIONS

Cable television (CATV) is a form of broadcasting delivered over hybrid fiber-coaxial (HFC) networks that transmits programs to paying subscribers through a physical land-based infrastructure of coaxial cables or through a combination of fiber-optic and coaxial cables rather than through the airwaves. Thus, CATV networks provide a direct link from a transmission center, such as a headend, to a plurality of subscribers located at typically addressable remote locations, such as homes and businesses.

Cable television networks based on coaxial distribution have been deployed for over half a century. The main function for early cable systems was to provide television service to areas where off-the-air reception was unavailable. In the past thirty years, most cities and county locations have been wired for cable television services. These services have evolved from 2-12 local off-air channels in the 1950s and 1960s to a variety of current services over a signal distribution service transmitting FM radio broadcasts, multi-channel TV programs, pay-per-view-movies (Video on Demand), information services such as videotext, and the like. Many cable systems now originate their own programming in an ever-increasing number of channels. In recent years, novel services have been made available to the subscribers, including interactive services. One such service regards a two-way, interactive communication involving access to established data communication networks, such as the Internet. CATV transmission, however, has been designed mostly to optimize downstream broadcasting; it was not configured for upstream receipt of information from subscribers. Even though upstream transmission has existed for years, recent advances and customer requirements have increased the kind and amount of upstream transmission to such an extent that the infrastructure for transmitting that upstream information has issues needing to be corrected and/or improved.

The signals that are carried over the coaxial cable delivery system are typically received at a headend facility. A CATV headend is the central transmission center operative to gather and to provide complex audio, visual, and data media throughout a geographical area, which can cover most or all of a small city. In big cities or metropolitan areas, multiple headend facilities cover separate areas but can be interconnected redundantly for reliable supply of signals. The signals at the headend are received through, for example, satellite receive antennas, antennas erected on a tower, microwave links, fiber-optic cables, and direct coaxial interconnects, and the external signals received through the various types of employed antennas include satellite, microwave, and local TV station broadcasts. Additionally, locally produced and prerecorded programs can be introduced into the system. The responsibility of the headend is to process and to combine the received signals for distribution to customers and businesses. In addition, the headend assigns a channel frequency to all the signals destined for cable distribution. These single received signals are multiplexed into a group of channels that are spaced 6 MHz apart, which are then offered to the subscribers selectively or are bundled as packages. Pay-per-view and special pay channels are added by keying the subscribers' set-top boxes or by phone authorization from the subscribers. If an upstream channel is operative in the network, the option of electrical authorization can be provided to the subscribers.

Programming has increased from the local off-the-air channels to include local, regional, national, and international programming. More and more channels have been added over the years so that a typical cable system now might offer hundreds of channels with analog and digitally compressed services. Once the signals have been processed at the headend, they can be distributed to the coaxial system through fiber-optic cables, microwave transmitters, or directly from the headend over the coaxial network.

A CATV system comprises a plurality of elements, which are operative in maintaining the flow of electrical data information through a coaxial conductor or through a combination of fiber-optic and coaxial cables to subscribers. The infrastructure of the system is required to span vast urban areas by cables installed underground or on high poles. It is routinely expected that the transmitted signals be kept at their highest possible fidelity having the lowest possible random energy interference level and this ability requires the CATV provider to periodically adjust the signals at each interconnect location.

Coupled between the headend and the subscriber end of the CATV system is a system of cables. A plurality of trunk cables, constructed of large diameter coaxial cables or of a combination of coaxial and fiber-optic cables, carry the signals from the headend to a series of distribution points. A typical cable system architecture includes a main trunk cable that is connected between the headend and these distribution points, referred to as hub stations or trunk/bridger stations. One or more feeder cables feed off the trunk/bridger station. Feeder cables branch out from the trunks and are responsible for serving local neighborhoods. Each feeder cable contains a number of taps disposed along the length of the feeder cable, and each tap contains a number of ports. A drop cable is connected between each port and a subscriber end and forms the familiar coaxial cables that enter directly into a CATV subscriber's premises. Terminal equipment is connected to the drop cable inside a CATV subscriber's home through a wall outlet. Among the more common terminal devices are televisions, VCRs, DVRs, set-top boxes, converters, descramblers, cable modems, and splitters. For a system offering two-way communications, the subscriber end also has a terminal that transmits signals upstream, in the return path of the cable system.

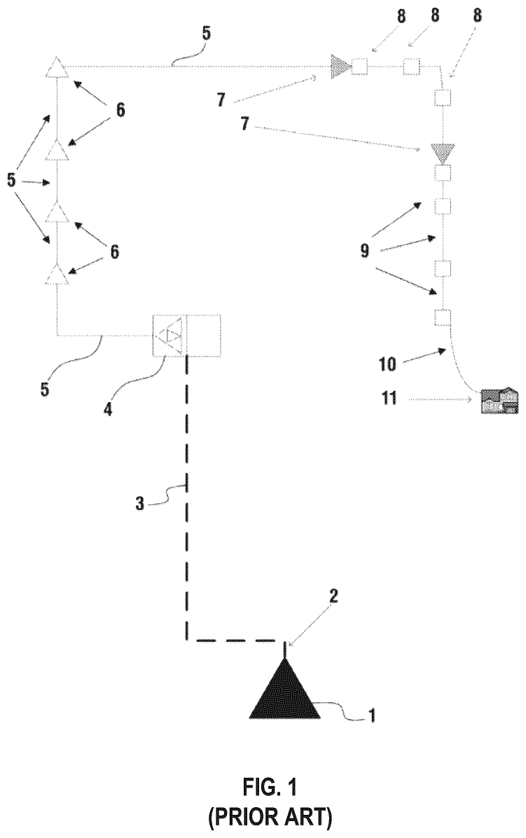

Traditionally, CATV systems were implemented with an HFC architecture in which the headend or hub site performed the bulk of signal processing. For instance, the headend can serve as a central location to handle processing, routing, and combining signals. In some cases, while this centralized architecture worked well for years, the increase in demand for higher bandwidth (due to internet growth, streaming services, etc.) can cause challenges. FIG. 1 is a schematic drawing of a typical hybrid fiber/coaxial cable-based broadband/CATV telecommunications system, according to one or more embodiments.

In some implementations, FIG. 1 can represent a typical an HFC system that is currently deployed to service CATV subscribers. In the illustrative example shown in FIG. 1, forward CATV signals can originate at a headend facility 1 and can be supplied to a digital fiber-optic transmitter 2. The digital fiber-optic transmitter 2 can transmit the forward CATV signals to a digital fiber-optic node 4 over fiber-optic cable 3 (shown with a dashed line). The digital fiber-optic node 4, which is also known as optical node or Remote PHY (RPHY) node, can also transmit reverse path signals from the subscribers to an optical digital receiver of the headend 1. An optical digital receiver in or adjacent to the digital fiber-optic transmitter 2 is not illustrated separately but can be typically located in the headend 1 to receive and process these return path signals from the optical node 4. The optical node 4 can process the optical signal and can provide a standard RF output signal. The standard RF output signal can then be provided to and carried over a coaxial cable 5 (a trunk or main line) to CATV trunk/network amplifiers 6 that are placed (in series) apart from one another with lengths of coaxial cable 5 therebetween. Depending upon the network architecture, the trunk/network amplifiers 6 can supply the signal to a network of distribution cables 9 that feeds signals to a smaller group of amplifiers, typically referred to as distribution or line-extender amplifiers 7. The distribution amplifiers 7 and distribution cable 9 can feed passive devices placed near an end user's location to tap off a main signal supply, which devices are sometimes referred to as distribution or subscriber taps 8. The distribution taps 8 can supply a signal tap for a subscriber's coaxial cable service drop 10. The subscriber service drop 10 enters a subscriber location 11 and provides the subscriber with desired services, such as basic, premium or high-definition TV channels, on-demand video, high-speed broadband Internet, and/or telephone. It is noted that this embodiment is just one of many different types of CATV distribution architectures and many cable TV operators utilize different devices and equipment to deploy their services to the end subscriber. However, in many cases, systems that utilize coaxial cable to distribute their services deploy a similar architecture of fiber-optic cable, coaxial cable, amplifiers, and passive distribution devices.

However, many traditional HFC amplifiers have limited corrective capabilities and lack real-time telemetry, automated fault detection and isolation, and autonomous network restoration. As a result, they cannot leverage AI and machine learning to dynamically optimize network performance through continuous parameter adjustment. Intelligent, remotely managed downstream and upstream RF spectrum control, including adaptive automatic gain control (AGC), can improve reliability, stability, and operational efficiency.

In some implementations, coaxial cables comprise a center conductor surrounded by a dielectric and an outer conductor, which may be formed as an aluminum outer shield. The coaxial cable attenuates signal power as a function of frequency and temperature. Frequency-dependent attenuation is primarily due to skin effect and dielectric loss, while temperature-dependent attenuation varies approximately linearly with conductor resistance. Because conductor resistance, dielectric properties, and cable geometry depend on the diameter of the center conductor and the characteristics of the dielectric material, different cable sizes exhibit different attenuation and spectral tilt characteristics.

As a result, signal levels and spectral tilt vary across the network as a function of cable type, cable length, frequency, and environmental conditions such as temperature. These variations accumulate over cascaded coaxial spans and amplifier stages, leading to time-varying gain errors, tilt errors, and margin degradation, particularly in wideband, high-order modulation systems such as DOCSIS OFDM and OFDMA. Accordingly, network amplifiers are typically required to provide automatic gain control (AGC) and slope (tilt) compensation to maintain signal levels and spectral flatness within specified limits.

However, conventional AGC and tilt control mechanisms are generally based on fixed or locally measured reference signals and lack visibility into end-to-end network conditions, upstream noise, or real-time service quality metrics. Consequently, they are often unable to optimally compensate for dynamic, spatially distributed impairments across the network. Booster amplifiers 6, 7 can be placed along the coaxial cable. The spacing of the amplifiers 6, 7 along a cable route can be determined by the loss of the route and is commonly selected based on the recommended operating gain of the amplifier 6, 7. Typically, the booster amplifiers 6, 7 can be located at points where the signal levels have been reduced to a pre-designed level. These amplifiers 6, 7 can be designed to add a minimum amount of noise and distortion to the processed signals. But the amplifiers 6, 7 generate additional noise at various points in their circuitry. The ratio of the signal-to-noise ratio (SNR) at the input of a device to the SNR at the output of the device is referred to as a noise figure of a given amplifier. As the amplifiers 6 and 7 are not perfectly linear, each amplification stage introduces additional noise and distortion components, as illustrated in FIG. 1 for a system comprising cascaded amplifiers. In addition to linear noise accumulation, the nonlinear behavior of cascaded amplifiers generates higher-order noise and distortion components due to signal-signal (distortion), noise-noise, and signal-noise intermodulation products that combine to form a composite nonlinear noise contribution.

In general, the output of a nonlinear amplifier can be modeled using a series polynomial representation with even- and odd-order terms as shown in the expression below

$$y = {c}_{1} x + {c}_{2} {x}^{2} + {c}_{3} {x}^{3} + … + {c}_{m} {x}^{m}$$

where c₁, c₂, c₃, . . . , cₘ are coefficients of Taylor's polynomial expansion of the nonlinear amplifier transfer function up to the m^{th} term. The input of the nonlinear amplifier can be expressed as

$$x = s + n$$

Where s is the sum of multicarrier signals, and n is the linear noise at the input of the first amplifier transmitted downstream from the RPHY node. Therefore, the total variance at the first amplifier input is

$${σ}_{x}^{2} = {σ}_{s}^{2} + {σ}_{n}^{2}$$

Using Price's theorem for memoryless nonlinear systems, the SNR/MER (≈CCN) at the output of the j^{th} channel, and the total composite signal power (TCP) can be expressed as

$${SNR}_{j} = \frac{{K}^{2} {σ}_{s , j}^{2}}{{c}_{1}^{2} {σ}_{n , j}^{2} + 2 {c}_{2}^{2} {σ}_{x , ( j )}^{4} + 6 {c}_{3}^{2} {σ}_{x , ( j )}^{6} + …} , j = 1 , 2 , … , N$$

$$and$$

$$TCP = {K}^{2} {\sum }_{j} {σ}_{s , j}^{2}$$

where N is the total number of channels. Here we assumed the amplifier output frequency response is flat with gain K. The TCP can be expressed in a simple closed form if received signal channels are flat at the amplifier input as TCP=K²NPₛ, where Pₛ is the per-channel input signal power level. In the SNR expression, the numerator term is the output signal power level at the j^{th} channel, and the first-term in the denominator is the linear noise term. The second- and third-terms in the denominator of the SNR expression represent the composite sum of the second- and third-order intermodulation products (i.e.,

$${σ}_{x , ( j )}^{4} and {σ}_{x , ( j )}^{6}$$

nonlinear noise power terms) that fall within the sub-band or bandwidth of the j^{th} channel. The signal-noise intermodulation component is signal-dependent, noise-like distortion whose power increases with input signal power level Pₛ which constitutes a dominant impairment in cascaded multicarrier systems. The system noise degradation behavior can be summarized as follows:
1^{st} order term creates linear noise independent of Pₛ
2^{nd} order term creates nonlinear noise proportional to

$${P}_{s}^{2}$$

3^{rd} order term creates nonlinear noise proportional to

$${P}_{s}^{3}$$

Note that both 2^{nd} and 3^{rd} terms are noise-like, not discrete spurs, in wideband QAM/OFDM multicarrier systems and contribute to noise growth, especially near upper and lower band edges and with asymmetries.

The achievable performance at the end of an amplifier cascade is limited by several factors, including the digital modulation format, the number of cascaded amplifier stages, the number of channels, channel configuration, and the TCP, all of which constrain the ability to achieve a desired level of performance. Accordingly, it is important to monitor the growth of noise and distortion, particularly near the lower and upper band edges of the digital channels being transmitted, where spectral regrowth of the noise, signal-noise, and distortion (i.e., nonlinear noise) tend to be most pronounced.

In accordance with the present approach, this monitoring is performed using distributed telemetry collected from network elements, including amplifiers, nodes, and/or headend equipment. Such telemetry may include, for example, measurements of in-band and out-of-band noise power, modulation error ratio (MER), error vector magnitude (EVM), spectral tilt, gain, output power, and temperature of the cable plant. These measurements enable detection of nonlinear noise growth, compression onset, and spectral regrowth in real time or near real time.

The collected telemetry is further used to drive closed-loop control of network parameters, including amplifier gain, slope (tilt), equalization, and operating point, so as to limit total composite power, reduce nonlinear noise accumulation, and maintain target performance margins across the cascade. In some implementations, the telemetry data is processed locally or centrally, optionally using predictive or machine-learning-based algorithms, to optimize operating points across multiple cascaded stages in a coordinated manner.

For machine-learning and artificial-intelligence models a physically accurate model is required for cascaded upstream and downstream amplifiers, which may operate close to saturation depending on cable loss as a function of frequency and temperature and cable plant loading conditions. We therefore adopt an experimentally fitted and characterized nonlinearity to model the amplifier transfer characteristic at each span of the cascade in the form

$$g ( x ) = tanh ( ax + b )$$

where coefficients a and b are dependent on amplifier temperature, gain setting, tilt setting, and time, and react to cable plant loading conditions at the input. This choice is particularly instructive because it clearly illustrates the differences and connections among three common analysis techniques: Price's theorem, the nonlinear transform method, and the series (polynomial) method. Although all three approaches are mathematically equivalent for g(x)=tanh(ax+b) in principle, only the transform method and Price's theorem remain valid and practical in the saturation regime, whereas the series method is restricted to the weakly nonlinear region.

In some implementations, the telemetry collected from the network is processed using machine-learning and artificial-intelligence models to estimate nonlinear operating margins, predict nonlinear noise growth, and optimize operating points across cascaded amplifier stages. Because the relationship between total composite power, temperature, plant configuration, and resulting nonlinear noise accumulation is highly nonlinear and depends on second-, third-, or higher-order effects as well as cascade interactions, data-driven models provide a particularly effective means of capturing these dependencies. The complexity of these interactions makes precise analytical models impractical.

The required computation rate can range from minute-by-minute to hour-by-hour, depending on environmental conditions. These include cable temperature variations driven by day-night cycles, periods of direct sunlight exposure during specific hours, and changes in AC power supply electrical loading. Electrical load fluctuations can be random and, under heavy and sustained operation, can increase cable temperatures by 10 to 20° C. or more above ambient. These combined effects necessitate adaptive, time-varying recalculation intervals to accurately track system behavior.

By way of example, the machine-learning models may be trained using historical telemetry data, laboratory characterization data, simulated data derived from nonlinear system models (including Price's theorem-based models), or combinations thereof. The models may learn mappings from observed telemetry features—including output power, spectral tilt, temperature, edge-of-band noise levels, MER, EVM, and channel loading—to predicted performance metrics such as nonlinear noise growth, MER margin, probability of errors, or proximity to compression.

The trained models may be used in real time or near real time (e.g., every second, every 10 s, every 30 s, every minute, every 10 min, every 30 min, every hour, every 3 hours, etc.) to evaluate candidate control actions, such as changes in amplifier gain, output power setpoints, slope (tilt), or equalization. The control system selects control actions that optimize one or more objectives, including, for example, maximizing MER margin, minimizing nonlinear noise accumulation, maximizing throughput, increasing allowable cascade depth, or reducing power consumption.

In some implementations, the machine-learning system operates in a closed-loop manner, continuously updating its predictions based on newly collected telemetry and adapting to changes in temperature, traffic loading, plant topology, or channel lineups. The learning system may employ, for example, supervised learning, reinforcement learning, or hybrid model-based and data-driven approaches.

In some implementations, the machine-learning system is constrained or guided by physical models, including Price's theorem-based nonlinear noise models, so as to ensure stable, explainable, and physically plausible control behavior. The learning method may be self-adaptive and telemetry-driven, forming a closed-loop control and learning system that continuously: 1. Predicts; 2. Acts; 3. Observes; 4. Learns; and 5. Updates. Both downstream and upstream models are continuously refined using live plant telemetry, synthetic physics-based data, and active probing. Historical operational data from real cable plants are obtained by collecting the live plant telemetry data over periods of time. These data provide accurate labels and serve as the “correct answers” for training, validating, and testing a supervised machine learning model; they are tied to real-world impairments and failure modes.

Generating large-scale labeled datasets using stochastic nonlinear mathematical and RF physical models may be used to produce densely-labeled synthetic data spanning operating regimes that are rare, dangerous, or impractical to explore in production networks.

Additionally, the system may perform controlled micro-perturbations to improve observability and labeling such that this enables continuous online self-identification and adaptation.

1. ML labels may be obtained from these three complementary sources as follows:
Historical Real-Plant Telemetry Data
a. MER/CCN degradation and failure events
b. Overload and amplifier compression conditions
c. Nonlinear noise growth and distortion signatures
d. Long-term drift due to temperature, aging, and loading conditions
e. Configuration and topology changes

2. Physics-Based Synthetic Data Generation
a. Nonlinear amplifier models using:
   i. Price's theorem
   ii. Nonlinear transform methods (e.g., tanh/AM-AM/AM-PM models)
   iii. Polynomial series method
b. Full nonlinear cascade models including:
   i. Coax cable loss and temperature dependence
   ii. Amplifier compression and memoryless nonlinearities
   iii. Noise accumulation and intermodulation growth
c. Monte-Carlo simulation sweeps over thousands of plant conditions:
   i. Cable length and topology
   ii. Cable temperature
   iii. Number and type of amplifier/cable cascades
   iv. Per-channel input power levels and tilt
   v. Channel plans and spectrum loading profiles

3. Active Probing and Online System Identification
a. Intentionally dither:
   i. Amplifier equalization parameters (gain and tilt)
   ii. Amplifier input power and slope
b. Observe:
   i. MER/CCN response
   ii. Nonlinear noise/distortion growth
   iii. Compression onset behavior
   iv. Linear noise floor changes
c. Use the observed response to:
   i. Dynamically label the current system state
   ii. Update local plant models
   iii. Refine ML predictions and control policies
      Because cable attenuation is:
Frequency dependent, wherein higher RF frequencies experience greater attenuation;
Temperature dependent, wherein attenuation increases as conductor temperature rises; and
Load dependent, wherein electrical loading increases conductor temperature and thereby increases attenuation;
   there exists a coupled relationship between cable attenuation and amplifier nonlinear noise growth and compression onset. Increased attenuation may require higher gain in downstream amplifiers and increased upstream drive levels, thereby reducing linearity margin and increasing risk of:
Intermodulation distortion (IMD),
Spectral nonlinear noise/distortion regrowth,
MER/CCN degradation, and
Compression.

In certain embodiments, cable loss can be modeled as:

$$L ( f , T , I ) = {L}_{0} ( f ) \cdot [ 1 + α ( T + Δ {T}_{l} ( I ) - {T}_{0} ) ]$$

where:
f=frequency
T=cable ambient temperature
I=RMS current flowing through the cable
ΔTₗ=RMS current load-dependent cable temperature rise
α=temperature coefficient
L₀(f)=frequency-dependent attenuation

In certain embodiments, the system models cable attenuation as a frequency-dependent and temperature-dependent function and incorporates the attenuation model into a physics-informed machine-learning engine to predict signal tilt variation, compression margin, and nonlinear distortion growth in both upstream and downstream directions.

In certain embodiments, a physics-informed machine-learning engine jointly models frequency-dependent and temperature-dependent cable attenuation and nonlinear amplifier behavior in both upstream and downstream directions to sequentially optimize cascade parameters while maintaining each amplifier within a predefined linearity margin and preventing compression under dynamic traffic and environmental conditions.

HFC systems have evolved to not only deliver TV channels but also provide broadband internet services using the data over cable service interface specification (DOCSIS) standard. The standard has improved in which DOCSIS 4.0 can support higher speeds and more efficient two-way communication. Some HFC systems today are implemented with a distributed access architecture (DAA) that improves network performance, increase capacity, and reduce operational costs, which can be achieved by moving certain functions and features closer to the premises of a user or subscriber. DAA decentralizes much of the signal processing that traditionally occurred at the headend and distributes it out to remote nodes or devices closer to the subscriber. In a DAA setup, certain functions like signal modulation, MAC layer processing, and RF signal generation are pushed out of the headend and distributed into the network. Today, DAA architecture is more commonly used. Baseband digital 10G, 25G, or 50G, etc. dense wavelength division multiplexing (DWDM) Ethernet can be used to transmit video data from headend to remote PHY (RPHY) RPHY or remote MAC (RMAC) nodes, e.g., over optical fiber (digital fiber optic link). DWDM baseband digital Ethernet data is then converted to 1.2 GHz, 1.8 GHz, 3 GHz, or 6 GHz, etc. wide several RF digital subcarrier signals by DOCSIS 3.x and 4.x, 5.x, 6.x etc. employing quadrature amplitude modulation (QAM) and orthogonal frequency-division multiplexing (OFDM) signals and transmitted via coaxial cable with splits and RF amplifiers in between to compensate for lossy cables and RF splits to the home. DAA can also replace analog fiber with Internet Protocol (IP) connections (digital fiber) and create software-defined networks with improved network efficiency that support node evolution with RPHY and RMAC nodes, increased network capacity, improved end-of-line signal quality, higher modulation rates, higher bit rates, improved spectral efficiency, more wavelengths per fiber, and/or the like. DAA can also have operational and capital expenditure benefits including reduced head-end power, space and cooling requirements, hub consolidation, ability to add QAMs without changing RF combining network, and/or the like.

Smart amplifiers may be deployed in coaxial networks that allow for remote control and monitoring of amplifier operational status. This can provide cable operators or technicians visibility into the health of their networks and allows them to proactively monitor performance metrics to resolve issues before they impact services. Some technologies leverage the long-range wide area network (LoRaWAN) standard to enable two-way communication between smart amplifiers and a centralized headend controller or local gateway node controller. To adapt LoRaWAN for cable networks, the HFC system described herein can incorporate existing narrowband digital forward (NDF) and narrowband digital return (NDR) communication channels that are available in DAA networks. In some implementations, the LoRaWAN protocol and physical layer can enable low-bandwidth two-way communication with smart amplifiers in a cable network. In some implementations, telemetric feedback from the centralized headend controller can be sent to the nodes through NDF and NDR channels. A technician can open or close communications of the nodes to enable, test, or restrict remote configuration, diagnostics, and/or signal optimization.

The HFC system described herein can implement part of the LoRaWAN signal chain on a portable or handheld node gateway device, or on an integrated gateway within one or more nodes, i.e., gateway node controller. The gateway node controller can utilize an RF test port of a RPHY node to inject downstream, and receive return path, communications to and from transponders interfacing with the smart amplifiers in the cable network. The gateway node controller may further be used by cable operators or field technicians for provisioning smart amplifiers during deployment and for local troubleshooting and diagnostics after installation. In some implementations, the HFC system can be further extended to a full headend controller solution that interfaces with both headend operational support system interface (OSSI) equipment and a mobile app outside of the DOCSIS network. In such implementations, the LoRaWAN PHY solution may be implemented within the headend controller, which acts as an auxiliary core within the DAA ecosystem and communicates with RPD Nodes using NDF and NDR channels. The LoRaWAN gateway MAC layer and amplifier management functions, which may be implemented within the mobile application on the gateway node controller, may be extended to the headend controller to enable centralized management and control of a plurality of RPD nodes and associated smart amplifiers.

In some embodiments, the HFC system described herein can include four main components: an endpoint, a gateway, a network server, and an application server. These components can use the HFC network as the communication medium instead of wireless communication. In some implementations, the endpoint can be a target device to be monitored and controlled in a LoRaWAN network. In a cable network, the endpoint can be a smart amplifier's transponder which receives and transmits RF frequency shift keying (FSK) signals from/to the gateway.

In some implementations, the gateway can function as an RF bridge that transmits and receives the FSK signals to and from the endpoint. In some cases, FSK signals can be modulated signals used to carry telemetry data in a reverse path. The gateway can perform FSK modulation, burst detection and demodulation of the signals and passes data to and from the network server. These functions can be performed at the handheld device in the context of a cable network application.

In some implementations, the network server can perform MAC Management process, message encryption/decryption, and aggregation of data. The network server can also send commands down to the endpoints during transmission windows. The network server can be structurally similar to a headend as described herein. In some cases, messages received by the network server can be stored for query by the application server. The application server can be a server that manages and stores data for an application running on a user's mobile device to monitor endpoints. The application server can poll data from the network server for display and sends commands back to the network server to be passed on to the endpoint through the gateway function.

The network server can operate as a MAC management system and data aggregator. After an endpoint (e.g., transponder and/or amplifier) joins the handheld gateway and the application server has requested collection, data can be periodically queried by the network server and stored on the handheld device for use by the application server.

In some embodiments, the HFC system described herein can enable remote monitoring, automatic gain control (AGC) and/or automatic gain/level and slope control (ALSC) and integration of transponders for real-time configuration. For instance, the HFC system can leverage digital Ethernet fiber optic connectivity, remote configuration capabilities, and AI and machine learning-driven optimization to improve network performance and maintenance efficiency.

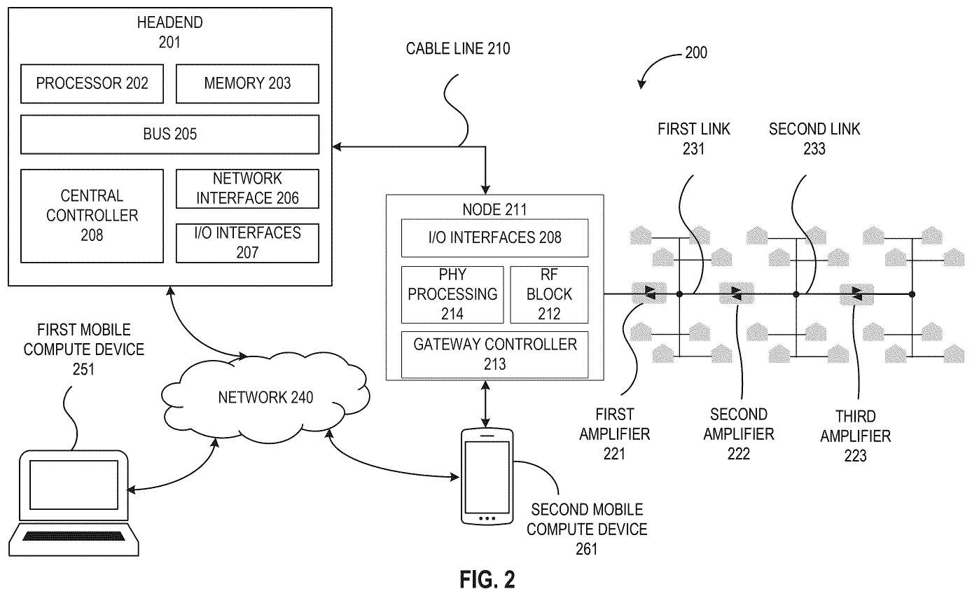

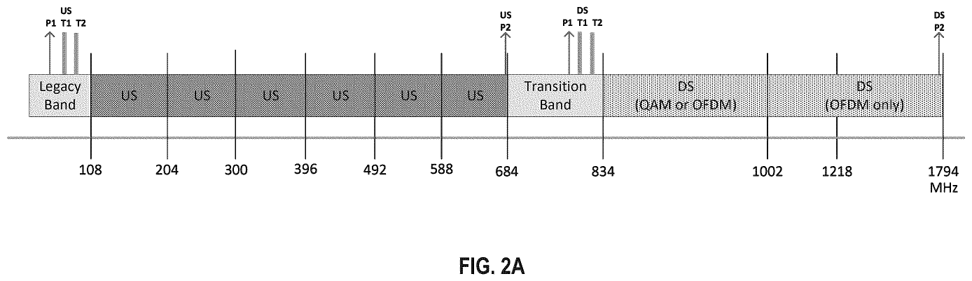

FIG. 2 is a block diagram illustrating a system 200 for cable network with HFC remote management, according to one or more embodiments. The system 200 can include a headend 201, a node 211, a network 240, a first mobile device 251, a second mobile device 261, and a chain of amplifiers (e.g., first amplifier 221, second amplifier 222, third amplifier 223) connected by links (e.g., first link 231, second link 233). In some cases, the links can be or include coax cable lines or fiber optics lines.

The headend 201 can be or include a compute device including a processor 202 and a memory 203 that communicate with each other, and with other components, via a bus 205. The bus 205 can include any of several types of bus structures including, but not limited to, a memory bus, a memory controller, a peripheral bus, a local bus, and any combinations thereof, using any of a variety of bus architectures. The headend 201 can be or include, for example, a computer workstation, a terminal computer, a server computer, or any machine capable of executing a sequence of instructions that specify an action to be taken by that machine, and any combinations thereof. The headend 201 can also include multiple compute devices that can be used to implement a specially configured set of instructions for causing one or more of the compute devices to perform any one or more of the aspects and/or methodologies described herein.

The headend 201 can include a network interface 206. The network interface 206 can be utilized for connecting the headend 201 to one or more of a variety of networks (e.g., network 240) and one or more remote devices (e.g., first mobile device 251, second mobile device 261, etc.) connected thereto. In some implementations, the network 240 can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network can be a wireless network such as, for example, a Wi-Fi or wireless local area network (“WLAN”), a wireless wide area network (“WWAN”), and/or a cellular network. In other instances, the network 240 can be a wired network such as, for example, an Ethernet network, a digital subscription line (“DSL”) network, a broadband network, and/or a fiber-optic network. In some instances, the headend 201 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 240 can be encrypted or unencrypted. In some instances, the network 240 can include multiple networks or subnetworks operatively coupled to one another by, for example, network bridges, routers, switches, gateways (e.g., headend gateway 208) and/or the like. In some implementations, the headend 201 can include I/O interfaces 207. The I/O interfaces 207 can be any suitable component(s) that enable communication between internal components of the headend 201 and external devices.

The processor 202 can be or include, for example, a hardware based integrated circuit (IC), or any other suitable processing device configured to run and/or execute a set of instructions or code. For example, the processor 202 can be a general-purpose processor, a central processing unit (CPU), an emerging or specialized processing Unit (XPU), a graphics processing unit (GPU), a tensor processing unit (TPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 202 can be configured to run any of the methods and/or portions of methods discussed herein.

The memory 203 can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor 202 to perform one or more processes, functions, and/or the like. In some implementations, the memory 203 can include extendable storage units that can be added and used incrementally. In some implementations, the memory 203 can be a portable memory (e.g., a flash drive, a portable hard disk, and/or the like) that can be operatively coupled to the processor 202. The memory 203 can include various components (e.g., machine-readable media) including, but not limited to, a random-access memory component, a read only component, and any combinations thereof. In one example, a basic input/output system (BIOS), including basic routines that help to transfer information between components within the headend 201, such as during start-up, can be stored in memory 203. The memory 203 can further include any number of program modules including, for example, an operating system, one or more application programs, other program modules, program data, and any combinations thereof.

The headend 201 can be or include a central controller 208. The central controller 208 can be a hardware and/or software component integrated within the headend 201 operating in an HFC network. The central controller 208 can be configured to serve as a centralized processing unit responsible for telemetry management, remote configuration, and signal optimization. The central controller 208 can be structurally similar to a compute device as described herein, and can include a processor, memory, network interfaces, and/or the like.

The central controller 208 can use two-way communication over one or more communication links such as, for example, a cable line 210. The cable line 210 can be a fiber optic cable line or a coax cable line. The cable line 210 can be a bi-directional digital Ethernet fiber-optic cable line. The cable line 210 can enable real-time data exchange with the node 211 (or multiple nodes) and an amplifier from a chain of amplifiers, allowing for continuous performance diagnostics and automatic adjustments. The node 211 can be or include Remote PHY Device (RPD), Remote MAC (RMAC) protocols, and LoRaWAN protocols. The node 211 may comprise a PHY processing module 310, for example, a 1×1 SED Remote PHY Device (RPD) module, and an RF block 312. The PHY processing module 310 may process digital baseband data for downstream and upstream communications. The RF block 312 may be configured to up-convert the digital baseband data into one or more quadrature amplitude modulation (QAM) and/or orthogonal frequency-division multiplexing (OFDM) modulated signals at corresponding RF carrier frequencies, thereby generating frequency-division multiplexed (FDM) signals and amplifying in the downstream direction. In the upstream direction, the RF block 312 may be configured to receive and amplify time-division multiple access (TDMA) and/or orthogonal frequency-division multiple access (OFDMA) modulated RF signals and down-convert the received RF signals to digital baseband signals for processing by the PHY processing module 310. The headend 201 may detect and/or receive signals from the node 211 that represents telemetric information of each amplifier from the chain of amplifiers (e.g., cascading amplifiers) or measurements of signal strength or integrity after passing through lines (e.g., first link 231, second link 233, etc.) between amplifiers. The headend 201 can analyze the telemetric information to provide corrective measures for ALSC or AGC (i.e., new or updated auto-alignment targets for the reference RF output power, gain and slope) and preventing signal level and nonlinear noise degradation over long distances on forward path (downstream) and reverse path (upstream) of the HFC system 200. In some implementations, the headend 201, node 211, or a combination thereof, may implement AI-based optimization and/or machine learning to enhance network efficiency, including improving amplifier alignment accuracy, stabilizing upstream and downstream signal levels, reducing nonlinear distortion, and dynamically compensating for cable loss and environmental variations. For instance, by predicting or detecting network load changes and environmental fluctuations at each amplifier or link, the headend 201 and/or node 211 may instruct the amplifiers to autonomously self-adjust to their new auto-alignment settings and allocate TCP and/or bandwidth more effectively, which can minimize the need for remote or on-site technician support. The machine learning engine is configured to detect current deviations from target signal levels and to predict future signal behavior based on historical telemetry and physics-constrained models, thereby enabling proactive adjustment of amplifier operating parameters.

The node 211 can be configured to serve as an intermediary (e.g., signal translation or distribution hub) that enables bi-directional communication between the headend 201 and the chain of amplifiers. The node 211 can include a Remote PHY Processing Device (RPD) 214, configured to digitize RF signals containing upstream NDR telemetry data channels and OFDMA channels into optical signals to be transmitted to the headend 201, e.g., central controller 208. The RPD 214 can also convert downstream optical signals into RF signals containing NDF telemetry data and QAM and OFDM channels to be distributed across the chain of amplifiers. The RPD 214 can be configured to aggregate telemetry data from the amplifiers and transmit corrective measure from the headend 201 to the amplifiers. The RF block 212 may act as an upconverter (for DS signals) and a downconverter (for US signals), and may amplify DS and US FDM signals.

The chain of amplifiers can include one or more amplifiers following a cascading configuration. In some implementations, the amplifiers can be smart amplifiers. The chain of amplifiers can include a first amplifier 221, second amplifier 222, and a third amplifier 223. The first amplifier 221 can be connected to the second amplifier 222 via a first link 231. The second amplifier 222 can be connected to the third amplifier 223 via a second link 233. RF signals can travel from the node to the first amplifier 221. The RF signals can further travel through the first link 231 to the second amplifier 222, and through the second link 233 to the third amplifier 233 downstream on a forward path. In some implementations, an amplifier (e.g., first amplifier 221, second amplifier 222, third amplifier 223, etc.) can include a transponder, an equalizer, and/or the like. The transponder can be configured for remote monitoring and amplifier setting adjustments. In some implementations, the first amplifier 221 is communicatively coupled to the node 211 using a RPHY architecture, in which the PHY layer processing is performed at the node by RPD 214. Digitized signals may be transported between the node 211 and the headend 201 over one or more digital fiber-optic links, and PHY-processed DOCSIS data may be transported between the node 211 and the amplifiers 221-223 using frequency-division multiplexing (FDM) over coaxial cables. In some implementations, the amplifier can be communicatively coupled to the node 211 over digital fiber-optic links, wherein the telemetry data of each amplifier can be digitized. Telemetry channels from other parallel amplifier networks can also be aggregated using time-division multiplexing (TDM) or wavelength-division multiplexing (WDM).

In some embodiments, the node 211 can generate multiple pilot tone signals at different frequences. The pilot signals can include reference measurements for signal strength, signal attenuation, noise, distortion, and/or signal-noise intermodulation products. The pilot signals can include a low frequency pilot signal and a high frequency pilot signal, or a single pilot that can move between low and high frequencies without impacting traffic. This is so, at least in part, to provide reference signals for multiple data channels at various levels of frequencies. The node 211 can inject the pilot signals on a downstream path (forward path) to each amplifier. Similarly, the pilot signals can be generated by an amplifier and sent upstream (reverse path) and back to the node 211. On the reverse path, the amplifiers can be configured to receive the pilot signals and use the pilot signals as reference signals, to detect/generate signal levels as part of the main status monitoring telemetry data.

The pilot signals can traverse downstream along the links (e.g., first link 231, second link 233, etc.). As the pilot signals propagate through multiple amplifiers along the links, the pilot signals can experience distortion, attenuation, degradation, etc., due to factors such as coax cable losses, environmental interferences, and/or temperature fluctuations. The status monitoring transponders (a.k.a. smart management transponders, SM transponders, SMT, or telemetry modules) can continuously communicate with the headend and node gateway, providing telemetry data that includes information on cable loss/slope in the upstream band (information attained through the node gateways upstream pilot signal level measurements where pilots are injected by amplifiers), cable loss/slope in the downstream band (information attained through the transponders downstream pilot signal level measurements where pilots are injected by the node gateway or amplifier tilt measurement of the FDM RF channels that are QAM and OFDM modulated), amplifier gain level, amplifier slope level, noise floor, amplifier DC rail voltage, and current, AC RMS voltage and current, amplifier temperature, environmental temperature, and/or the like.

Traditionally, transponders could receive telemetric feedback from a central server on a forward (downstream) path to make operational changes to the amplifiers. In the present case, a transponder can also generate pilot signals (e.g., low frequency and high frequency) and inject the pilot signals upstream on the reverse path, such that pilot signals can traverse both downstream and upstream simultaneously.

In an example, a first amplifier 221 can send a pilot signal (or plurality of pilot signals) upstream to the node 211. The pilot signal may include data describing the characteristics of itself, e.g., level(s) and tilt at launch. The node 211 may then measure the characteristics of the received pilot signal and compare them to the described (or already known) characteristics to determine the amount of signal degradation, e.g., attenuation, distortion, tilt, etc. that occurs between first amplifier 221 and the node 211. The data created by the measurement of the pilot signal, i.e., telemetric measurement data, may be sent upstream to central controller 208. Upon receiving the telemetric measurement data, one or more of: the central controller 208; the node gateway 213; the first mobile compute device 251; and the second mobile compute device 261; may determine what adjustments should be made by the first amplifier 221 to optimize the upstream signal between the first amplifier 221 and the node 211. Then the central controller 208 (or node gateway 213, etc.) may send telemetric feedback data downstream to the first amplifier 221 with instructions to make those adjustments. After making the adjustments, the first amplifier 221 may send another pilot signal upstream, and the upstream controller may issue additional telemetric feedback including either further instructions or confirmation that the signal quality is sufficiently optimal.

Following these steps, a similar process may occur with the second amplifier 222 and the third amplifier 223. In this way, the amplifiers may be calibrated and recalibrated without requiring a field technician to visit them. The calibration process may occur upon initial setup, as well as at regular intervals, upon detection of a change in conditions (e.g., temperature), or upon manual initiation.

In another example, the third amplifier 223 may send a pilot signal to the second amplifier 222. The second amplifier 222 may measure the pilot signal and send telemetric feedback data to the third amplifier 223 (or may send telemetric data to the gateway controller 213, which may send telemetric feedback data to the third amplifier 223), which the third amplifier 223 may use to perform AGC/ALSC. Similarly, the first amplifier 221 and second amplifier 222, and the node 211 and first amplifier 221, may perform this process.

Injecting one or more dedicated pilot signals in the upstream path provides a stable reference signal that enables a node gateway controller and/or a spectrum analyzer associated with one or more upstream amplifiers to capture, measure, and generate corrective feedback in the form of telemetry data. Such telemetry data may be communicated to the amplifiers via one or more downstream telemetry channels and used to automatically align attenuation and slope parameters of the amplifiers, thereby establishing desired gain, equalization, tilt, output power levels, and/or other operating parameters.

In certain embodiments, auto-alignment of the upstream or reverse path during initial installation, and maintenance of gain following upstream automatic gain control (AGC) and/or automatic level and slope control (ALSC), may be more challenging than for the downstream or forward path. This increased complexity arises because upstream RF channel levels are inherently variable and unpredictable due to transmissions from multiple subscriber premises at differing power levels, cumulative noise and interference, bursty traffic patterns, sporadic data transmissions, and similar factors. Additionally, in the downstream or forward path, the headend 201 or node 211 can more readily monitor and analyze live traffic or RF channel signals to perform alignment and control adjustments for the forward path of one or more amplifiers. In contrast, upstream transmissions are typically bursty in nature, making it difficult to lock onto a stable and continuous reference signal for measurement and control purposes.

In certain embodiments, upstream pilot signals enable upstream amplifiers to be automatically aligned sequentially, one amplifier at a time, during initial installation as well as while live upstream traffic is present. In such embodiments, a first upstream amplifier 221 is configured to transmit one or more upstream pilot signals, which are received and measured at a node gateway controller 211. The node gateway controller 211 generates telemetry data based on the measured pilot signal levels and communicates the telemetry data to the first upstream amplifier 221 via one or more downstream telemetry channels to correct gain and slope settings.

Following alignment of the first upstream amplifier 221, subsequent upstream amplifiers (222, 223) are aligned in sequence in a similar manner. At the node 211, the gateway controller 213 measures received upstream signal levels and transmits corresponding telemetry data to each upstream amplifier to dynamically adjust gain and slope parameters. This sequential alignment maintains a substantially constant signal level at the node input, at the upstream input of each amplifier in the cascade, and at amplifier output levels, regardless of variations in cable loss, noise accumulation, or environmental conditions.

In further embodiments, upstream pilot signals enable upstream amplifiers to dynamically adjust operational parameters, including gain, slope, and output power, while live traffic is present, without interfering with upstream service traffic or telemetry channel allocations, thereby maintaining consistent output levels during normal network operation. This is known as upstream AGC or ALSC using upstream pilot signals and downstream telemetry communication.

In other embodiments, downstream pilot signals generated by a node gateway controller enable upstream amplifiers to be quasi-aligned sequentially, one amplifier at a time, during initial installation, with or without live downstream traffic present. In such embodiments, the node gateway controller is configured to transmit one or more downstream pilot signals and associated telemetry data, which are received and measured at a first upstream amplifier using a signal level meter (SLM) (a.k.a. signal monitoring nodule (SMM)), which is capable of capturing the frequency spectrum of the input and output upstream and downstream signals and system noise for high-resolution spectrum analysis, and a smart management transponder (SMT or SM transponder or status monitor transponder).

Based on measured RF levels of the downstream pilot signals, the first upstream amplifier 221 is configured to extrapolate cable loss characteristics from a downstream frequency band to an upstream frequency band and to determine corrective gain, slope, and equalization settings. By way of example, in a high-split frequency-division duplex (FDD) system, downstream measurements in a frequency range from approximately 258 MHz to 1794 MHz may be used to estimate upstream loss characteristics in a frequency range from approximately 5 MHz to 204 MHz.

Similar quasi-alignment operations may then be performed sequentially for additional upstream amplifiers in a cascade. When live downstream service traffic is present, measured characteristics of active downstream RF channels may additionally or alternatively be used to estimate cable loss and alignment parameters for the upstream amplifiers.

In further embodiments, downstream pilot signals enable one or more upstream amplifiers to dynamically adjust operational parameters, including gain, slope, and output power, while live traffic is present, without interfering with upstream service traffic or telemetry channel allocations, thereby maintaining substantially consistent output levels during normal network operation. This technique may be referred to herein as upstream quasi-automatic gain control (quasi-AGC) or upstream quasi-automatic level and slope control (quasi-ALSC), in which downstream pilot signals and/or measured characteristics of live downstream service traffic are used in conjunction with downstream telemetry communications to control upstream amplifier operating parameters.

After performing upstream auto-alignment or quasi-alignment for AGC or quasi-AGC, the amplifiers (or transponders in the amplifiers) can transmit both its telemetry data and pilot signal feedback upstream to the node 211. The node 211 can aggregate the telemetry data from multiple amplifiers, digitize the telemetry data into optical signals, and forward the optical signals to the headend 201 for further analysis and for further fine-tuning of amplifier settings to maintain signal integrity.

The telemetry data can include measurements representing signal degradation of the pilot signals and/or RF signals through the links from a previous amplifier. For instance, the pilot signals and/or RF signals from the third amplifier 223 through the second link 233 can be degraded. The headend 201 can be configured to provide corrective measures based on the telemetry data to optimize the RF signals. In some implementations, the telemetry data can include information about pilot signal levels, RF signal strength (for example, per channel power levels and tilt levels), total composite power (TCP), signal-to-noise ratio (SNR), or carrier-to-composite noise distortion (CCN), gain and attenuation parameters, tilt parameters, input/output power levels, temperature readings, power level, gain settings, power supply voltage levels, network performance, and/or the like.

The node 211 and/or node gateway 213 can receive the telemetry data that each transponder generated and can digitize them to be sent to the headend 201 or the headend gateway 208 via the fiber optic cable line 210. The telemetry data can be digitized and telemetry channels from other parallel amplifier networks can be aggregated using time-division multiplexing (TDM) or wavelength-division multiplexing (WDM).

In some implementations, the signal transmissions can be controlled by a remote compute device such as, for example the first mobile device 251 or the second mobile device 261. The first mobile device 251 and the second mobile device 261 can each be structurally similar to any compute device as described herein. In some implementations, the first mobile compute device 251 and/or the second mobile compute device 261 can be configured to cause the headend 201 or node 211 to transmit corrective signals, based on the telemetry data, downstream on the forward path to each amplifier from the chain of amplifiers to cause each amplifier to self-adjust operational parameters. The corrective signals can include telemetric feedback for the parameters of each amplifier such as, for example, AGC or ALSC. The node 211 or the node gateway 213 can convert optical signals containing the corrective signals to RF signals to be distributed to each amplifier downstream (forward path). In some implementations, the telemetric feedback can be generated using machine-learning.

In some implementations, the first mobile compute device 251 can be a computer operated by a user at an office setting. The user can monitor the amplifiers and generate corrective signals via the headend 201 while operating the first compute device 251.

In some embodiments, instead of communicating with the headend 201, the second mobile device 261 can be configured to communicate with the node 211 to generate the telemetric feedback to be directly distributed to the amplifiers. For instance, a technician can monitor and remotely perform corrective measures for each amplifier without manually performing the corrective measures at each amplifier location. The second mobile compute device 261 can be a handheld device (e.g., tablet, smartphone, etc.), that a technician can use at the field or near the field to monitor and configured the amplifiers instead of visiting each amplifier manually.

In some embodiments, each amplifier can be configured to self-adjust operational parameters based on the pilot signals traversing upstream on the reverse path through each amplifier, without receiving the corrective signals from the headend.

As discussed above, signal transmission occurs in two main paths: the forward path (downstream) and the reverse path (upstream). Signals can travel from the headend 201 through the node 211 and amplifiers (e.g., first amplifier 221, second amplifier 222, third amplifier 223, etc.) to subscriber homes in the forward path, while subscriber signals return via amplifiers and the node 211 back to the headend 201 in the reverse path. Signal conditioning can be achieved through attenuators and equalizers, which compensate for signal degradation, temperature variations, and cable loss.

The pilot signals serving as continuous reference signals can also be used for monitoring network integrity. The amplifiers can perform FSK modulation to encode telemetry data onto an RF carrier for upstream transmission and amplifier self-adjustment. In the downstream direction, signal levels can also be adjusted using live broadcast channels, whereas upstream gain control can use the pilot signals injected at various amplifier locations.

Remote configuration can be enabled via Bluetooth or WiFi-enabled handheld devices (e.g., remote compute devices), to allow technicians operating them to adjust amplifier settings in the field or remotely. The headend 201 can provide remote control capabilities, enabling centralized monitoring of all network amplifiers. Adjustments to gain, attenuation, and tilt can be performed remotely via a software interface. In some implementations, the transponders in the amplifiers can detect pilot signals to modify gain and attenuation dynamically. In the upstream direction, multiple pilot signals at different frequencies can assess loss across amplifiers to optimize gain settings accordingly.

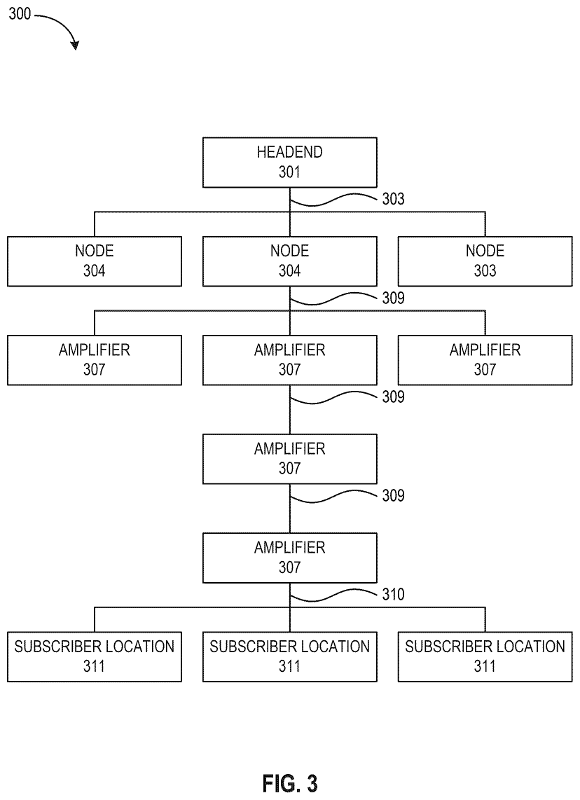

FIG. 3 is a diagrammatic illustration of an HFC network 300, according to one or more embodiments. The HFC network 300 can be structurally similar to the system 200 of FIG. 2. As shown in FIG. 3, the HFC network 300 can illustrate the signal distribution path(s) from a headend 301 to subscriber locations 311 through nodes 304 and amplifiers 307. The headend 301 can be consistent with the headend 201 of FIG. 2. The nodes 304 can be consistent with the node 211 of FIG. 2. The amplifiers 307 can be consistent with the first amplifier 221, second amplifier 222, and/or third amplifier 223 of FIG. 2.

The headend 301 can be the central facility for the HFC network 300 and can distribute signals via fiber-optic cables 303 to one or more nodes 304. The nodes 304 can be configured to convert optical signal from the headend 301 to RF signals for transmission over the HFC network 300. In some cases, each node can be configured to serve a specific geographical location or area, and can connect to multiple amplifiers 307 via coaxial lines 309.

In some implementations, the amplifiers 307 can be placed in a cascade configuration. The placement and/or configuration of the amplifiers can compensate for signal loss over long distances. The amplifiers 307 can boost signal strength as signals propagate toward the subscriber locations 311. In some implementations, the subscriber locations 311 can serve as the final destination of the HFC network 300 where services such as, for example CATV can be delivered. Signals from the amplifiers 307 can be distributed to the subscriber locations 311 via coaxial cables 310.

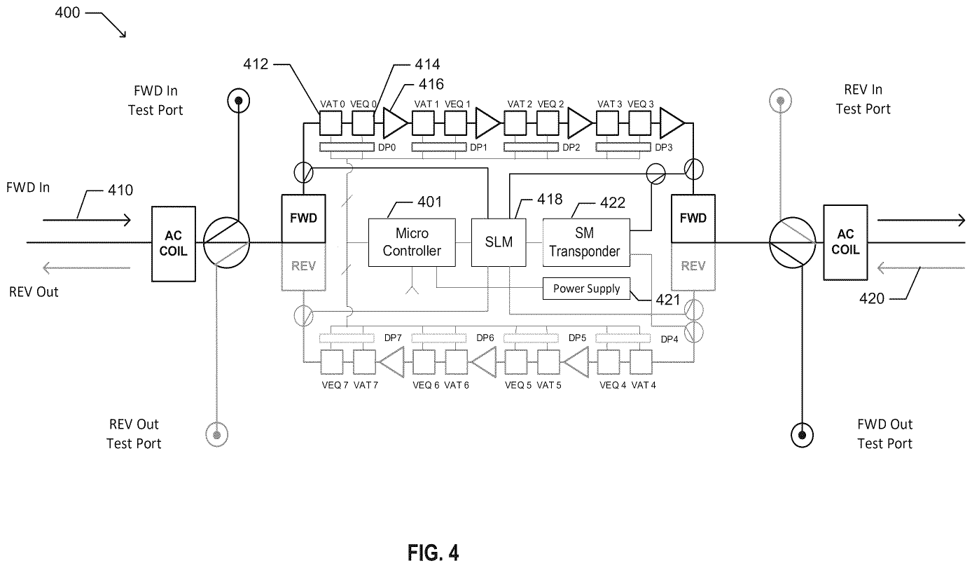

FIG. 4 is an example schematic diagram of an amplifier 400 of the system of FIG. 2, according to one or more embodiments. The amplifier 400 can be consistent with the amplifiers 221, 222, 223 of FIG. In some implementations, the amplifier 400 can be an RF and/or smart amplifier that includes an integrated telemetry module 423 (e.g., transponder).

The amplifier 400 can be configured to process, amplify and/or monitory forward (downstream) and reverse (upstream) signals using pilot signals and/or telemetry data. The amplifier 400 can be configured to allow for real-time gain adjustments or AGC, diagnostics, and/or remote monitoring. The amplifier 400 may be similar or identical to the amplifier station 1000 described in US 2026/0019093, the contents of which are incorporated by reference in their entirety.

As shown in FIG. 4, a downstream signal containing broadcast content (e.g., videos, data, internet, etc.) for subscribers can be received via the forward input (FWD In) by the amplifier 400 from a node (or previous amplifier). Another downstream signal containing injected pilot signals can be received at the FWD In. The downstream signals can follow a forward path 410 and pass through one or more attenuators 412, equalizers 414, and amplifiers 416, to adjust gain and equalization. The amplifier 400 can also include a signal level measurement module (SLM 418) configured to measure power levels for each channel (upstream and downstream), pilot signals, as well as nonlinear noise and distortion at the upper and lower band edges of the service channels. The SLM 418 may be a spectrum analyzer configured to analyze both traffic and telemetry data. At the forward output (FWD Out), the downstream signals, which can be attenuated and/or amplified along the forward path 410, can be transmitted to the next amplifier or subscriber location. In some cases, just before the FWD Out port, the amplifier 400 can be configured to test and/or monitor the downstream signal characteristics.

On a reverse path 420 and at the reverse input (REV In) of the amplifier 400, an upstream signal from subscriber locations can be received. In some implementations, the upstream signal (e.g., reverse signal) can be tapped-off (and/or filtered) and attenuated, equalized, and/or amplified, before being sent further upstream to the next amplifier or to the node at the reverse output (REV Out).

In some implementations, the amplifier 400 can include a micro controller 401 configured to analyze and/or process pilot signals and telemetry data. The micro controller 401 can be configured to communicate with the SMT 422, a universal asynchronous receiver transmitter (UART). The micro controller 401 can also be configured to adjust amplifier settings based on feedback of the telemetry data from the headend. In some implementations, the SMT 422 can be configured to monitor the performance of the amplifier 400 using the pilot signals as a reference, and to generate telemetry data. The SMT 422 can interface with the micro controller 401 for automated amplifier adjustments based on feedback of the telemetry data. In some implementations, the amplifier 400 can include a power supply module 421 configured to provide power to the amplifier 400 for signal amplification and telemetry functions.

In some embodiments, the amplifier 400 can include an upstream port (e.g., REV in Test Port or REV Out Test Port) adapted and configured for coupling with coax cable and a downstream port (e.g., FWD In Test Port or FWD Out Test Port) adapted and configured for coupling with coax cable. The amplifier 400 can include a pilot signal generator that is communicatively coupled to the downstream port and configured to generate and output, at the downstream port, multiple pilot signals. In some implementations, the amplifier 400 can include an upstream pilot signal generator that is communicatively coupled to the upstream port and configured to generate/output at the upstream port multiple upstream pilot signals. The pilot signal generator may be the micro controller 401 and/or the SMT 422. In some implementations, the upstream pilot signals can include at least one low-frequency pilot signal having a frequency below a payload band and at least one high-frequency pilot signal having a frequency above the payload band. The payload band can include one or more subcarrier channels for RF signals.

The micro controller 401 can be communicatively coupled to the upstream port and the downstream port. The micro controller 401 can be programmed to receive feedback based on signal degradation of an upstream or downstream pilot signal from equipment (e.g., headend, previous amplifier, next amplifier, node, etc.) communicatively coupled to the upstream or downstream port. The micro controller 401 can be further programmed to adjust gain from the downstream port to the upstream port, and vice versa, based on the feedback. In other words, the pilot signals can be used as reference signals for telemetric feedback for real-time adjustments of parameters or settings of the amplifier 400, to ensure stable upstream and downstream communication, reduced manual maintenance, and improved network efficiency. The feedback can include controller-readable instructions. In some implementations, the downstream pilot signals and the upstream pilot signals can conform to LoRaWAN protocol.

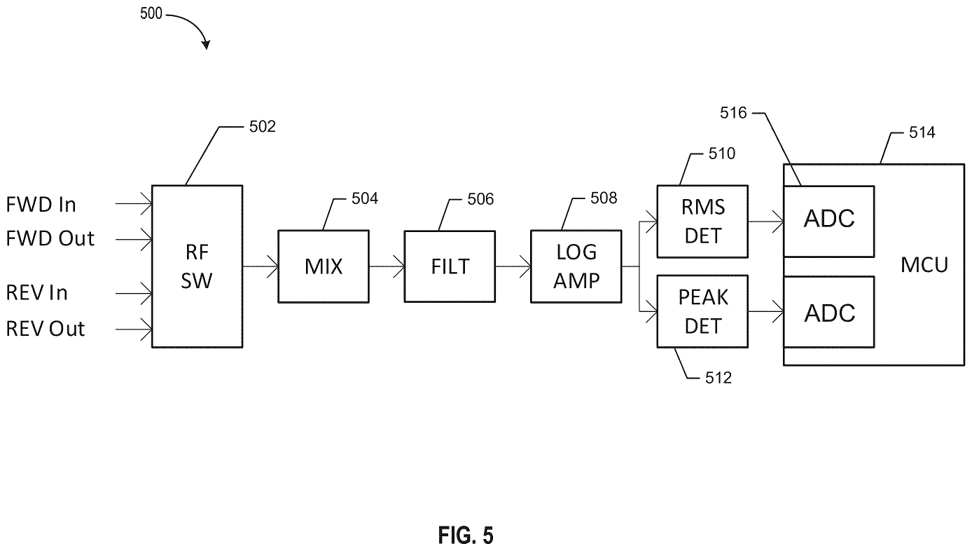

FIG. 5 is an example schematic diagram of a telemetry and signal level monitoring system 500 used in the amplifiers 221, 222, 223 of FIG. 2 or amplifier 400 of FIG. 4, according to some embodiments. The SLM 500 may be an example of an SLM 418. The SLM 500 can be configured to monitor, e.g., peak per-channel signal power level, average per-channel signal power level, and total composite power (TCP) levels of forward and reverse data channels including system noise and SNR/CCN levels. The system 500 can be integrated within the amplifier(s) as described herein. The SLM 500 can be configured to remotely perform monitoring, diagnostics, and real-time adjustment of the forward and/or return path signals.

The SLM 500 includes an RF switch 502, into which it may receive a set of signal(s) from the forward input and output, and reverse input and output stages. The signal(s) then go into a mixer 504, which may have a synthesizer-based local oscillator inside. After the mixer 504, the signal(s) go through a filter 506, which may be a saw filter, that rejects any images, i.e., data from unwanted spectra. The signal(s) then pass through a (high dynamic range) logarithmic amplifier 508 before going into one or both of a root-mean-squared (RMS) detector 510 and a peak detector 512. The RMS detector 510 measures the average power level of the signal selected in the mixer, while the peak detector 512 measures the peak power of a signal, which is especially useful when the measured channel is bursty. The signal(s) then go through an analog-digital converter (ADC) 516 before being received by a microcontroller unit (MCU) 514. The MCU may be part of the SLM 500, or it may be the amplifier MCU 401.

In some implementations, the system 500 can include multiple test ports that facilitate signal access for monitoring and control. For instance, the REV TX FSK/Pilot Injection Level or the REV RX In and REV TX Out traffic channel Level measurements can enable the injection of an FSK modulated signal into the reverse path for network diagnostics and performance monitoring. In some cases, the telemetry data can be modulated onto a pilot signal and injected into the reverse path for monitoring purposes.

In some implementations, the FWD Out Test Port can allow for the measurement of the telemetry data before it is transmitted further downstream. The REV In Test Port can provide an entry point for measuring the strength of the pilot signal on the reverse path before amplification or processing, while the REV Out Test Port can enable monitoring of the pilot signal strength before it is transmitted upstream to the node (e.g., node 211 of FIG. 2) or the headend (e.g., headend 201 of FIG. 2).

In some implementations, the RF Switch 502 can be configured to selectively route pilot signals to the forward path or the reverse path. Once selected, the pilot signals can be routed to the Logarithmic Amplifier (LOG AMP 508). In some cases, the RF switch 502 can be configured to ensure that each data channel can be analyzed independently.

In some implementations, the LOG AMP 508 can be configured to convert input signal power into a logarithmic voltage output, which can be transmitted to the analog-to-digital converters (ADCs 516) of the micro controller 514. The micro controller 514 can be configured to process the digital signals.

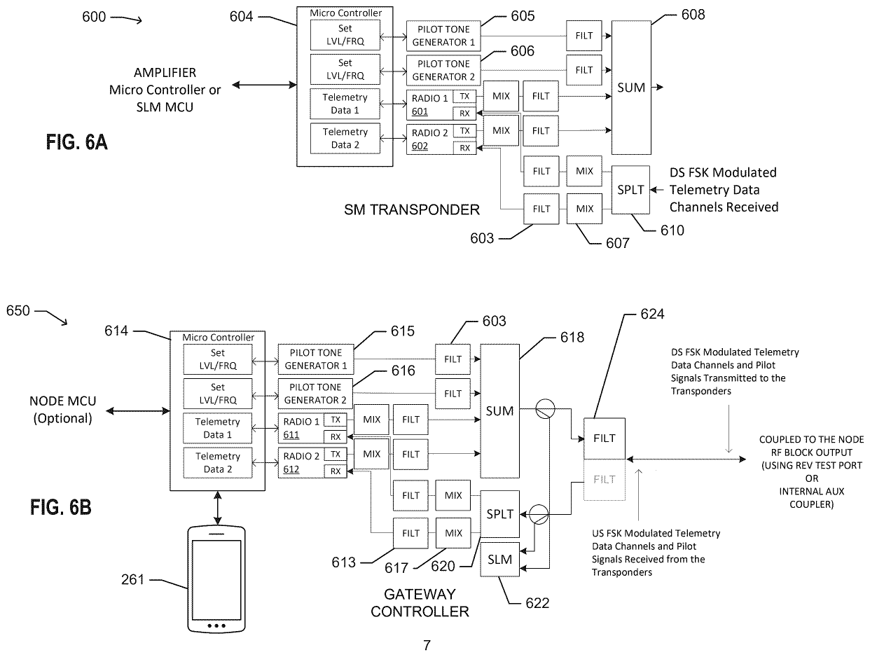

FIG. 6A is a schematic diagram of an example of an SM transponder 600 of the amplifiers 221, 222, 223 of FIG. 2 or amplifier 400 of FIG. 4, according to some embodiments. The SM transponder 600 may be consistent with the SM transponder 422 of FIG. 4. In some implementations, the SM transponder 600 can be configured to generate and/or receive modulated signals for remote monitoring and diagnostics in an amplifier. In some implementations, the SM transponder 600 can include two radio controllers such as Radio 1 601 and Radio 2 602. Radio 1 601 and Radio 2 602 may be STM32WL55 radios, and may be LoRaWAN radios controllers. Radio 1 601 can include a transmitting channel and a receiving channel. Radio 2 602 can also have a transmitting channel and a receiving channel. The transmitting channels can be configured to generate modulated (e.g., FSK modulated) telemetry data and the receiving channels can be configured to receive modulated signals. In some implementations, the micro controller 604 can communicate with Radio 1 601 and the Radio 2 602 via serial interfaces.

Pilot tone generator 1 605 and pilot tone generator 2 606 and can generate pilot signals that can be injected upstream or on the reverse path. The pilot signals can traverse through cable lines connecting amplifiers on the reverse path and up to the node.

In some implementations, the telemetry module 600 can include a SUM 608 in the forward path and a splitter 610 in the reverse path to transmit and receive the telemetry data on the reverse path and forward path, respectively. Between the radios 601 and 602 and the SUM and splitter 608 and 610, there may be a mixer 607 and a filter 603, such as a selectable lowpass filter, bandpass filter banks, etc. There may be filters 603 between the pilot tone generators 605, 606, and the SUM 608.

The micro controller 604 can be configured to communicate with a controller 401 of the amplifier described herein to enable remote configuration, diagnostics, gain adjustments, and/or the like based on telemetric feedback (e.g., corrective signals). The micro controller 604 may be capable of setting levels and frequencies of pilot signals, and of receiving and processing telemetry data, such as received pilot signals, pilot signal information, telemetry feedback data, corrective instructions, etc.

In some implementations, the radios 601, 602, can generate telemetry signals from measured telemetry data, which can be modulated (FSK) or unmodulated. These signals can pass through couplers and test ports to be inserted into the RF path. The transponder 422 of an amplifier can process these signals, adjusting gain, equalization, and attenuation based on telemetric feedback from the headend.

FIG. 6B is a schematic diagram of an example of a gateway controller 650, which may be a node gateway controller 213. The gateway controller 650 may be embedded in a node, connected to a node, or portable, and capable of being connected to an amplifier. For example, the gateway controller 650 may be capable of coupling to auxiliary input and/or test port on an RF block 212, such as a test port on the reverse input side. The gateway controller 650 may contain similar components as the SM transponder 600, such as a radio 1 611, radio 2 612, pilot tone generator 1 615, pilot tone generator 2 616, SUM 618, splitter 620, and micro controller 614, which may each have similar functionality to the corresponding components described in relation to SM transponder 600. Between the radios 611 and 612 and the SUM and splitter 618 and 620, there may be a mixer 617 and a filter 613, such as a selectable lowpass filter, bandpass filter banks, etc. There may be filters 613 between the pilot tone generators 615, 616, and the SUM 618. At the input/output 624, there may be a filter, such as a selectable diplex filter bank, splitter, and/or directional coupler. The gateway controller 650 may be interfaced with, and controlled by, a second mobile compute device 261, such as a smartphone, tablet, laptop, etc. For example, it may be accessed via an app or other software, and via a wired or wireless (e.g., Bluetooth, Wi-Fi, internet) connection. The input and output of the forward and reverse paths may additionally connect to an SLM 622, which may be an SLM 500.

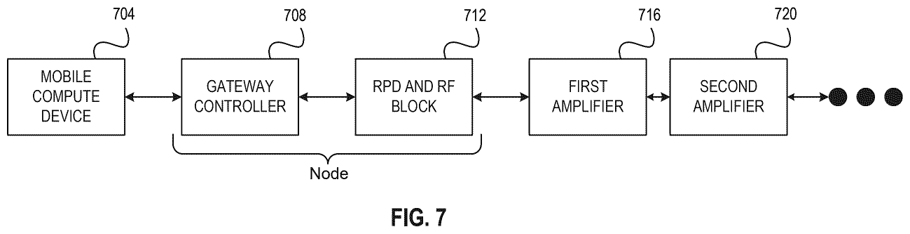

FIG. 7 is a diagrammatic illustration of a LoRaWAN node gateway and network server, according to one or more embodiments. In an embodiment of an HFC network without a headend, the LoRaWAN device can function as both a gateway and the network server, like the headend, for amplifiers having transponders. As shown in FIG. 7, a mobile compute device 704 can communicate with a node gateway controller 708. The mobile compute device 704 can operate or run an application to monitor or configure the amplifiers. For instance, a user can view telemetry data, adjust amplifier settings, and/or diagnose network issues remotely through a Bluetooth or Wi-Fi connection.

The node gateway controller 708 can be a device that bridges the communication between the mobile compute device 704 and the HFC network. In some cases, the node gateway controller 708 can use LoRaWAN protocol to transmit and receive signals over long distances. The node gateway controller 708 can also serve as a relay between the mobile compute device 704 and a remote PHY device RF tray (RPD and RF block 712). The node gateway controller 708 and the RPD & RF block 712 can have RF test points which can be a testing interface where RF signals can be monitored, injected, or measured. The RF test points can enable technicians to analyze signal strength, noise, and telemetry performance.

In some implementations, the RPD & RF block 712 can be responsible for converting digital optical signals to RF signals (downstream) and RF signals to digital optical signals (upstream). The RPD & RF block 712 can be similar to the node 211 or node gateway controller 213 of FIG. 2. In some cases, the RPD & RF block 712 can be configured for DOCSIS signal processing, including modulation/demodulation and frequency conversion.

The mobile compute device 704 can communicate with amplifiers such as first amplifier 716 and second amplifier 720 through their transponders using a unique identifier. In some implementations, the node gateway controller 708 can support up to 60 amplifier endpoints (transponders) joining, per mobile compute device. The mobile compute device 704 can be consistent with the second mobile compute device 261 of FIG. 2.

In some implementations, the node gateway controller 708 can contain a 75-ohm RF interface to connect to the RF test points on the RPD & RF block 712. This interface can provide access to the transmit and receive communication channels between LoRaWAN transponder endpoint devices and the node gateway controller 708. The mobile compute device 704 can collect operational statuses from the first amplifier 716 and the second amplifier 720 via the transponder and can send configuration messages to the transponder to control each amplifier. In some cases, the amplifiers can support the transmission of REV (upstream) telemetry data at a frequency range of 9 to 85 MHz, 9 to 204 MHz, 9 to 396 MHz, 9 to 492 MHz, 9 to 684 MHz In some cases, the transponder can support the reception of FWD (downstream) telemetry data within the 108 MHz to 1794 MHz, 258 to 1794 MHz, 492 to 1794 MHz, 606 to 1794 MHz, and 834 to 1794 MHz, respectively.

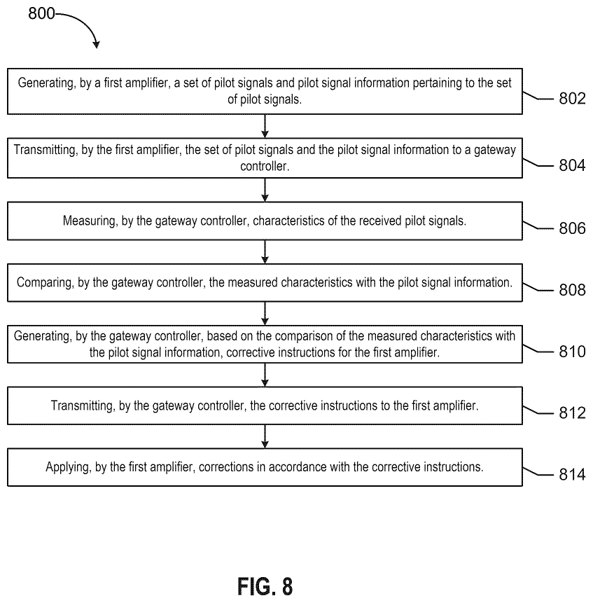

FIG. 8 is an exemplary flowchart of a method 800 of improving network performance. At 802, a first amplifier generates a set (i.e., one or more) of pilot signals and generates pilot signal information pertaining to the set of pilot signals. The pilot signal information may include, e.g., launch levels and frequencies of the pilot signals. At 804, the first amplifier transmits the set of pilot signals and the pilot signal information to a gateway controller, e.g., node gateway controller 213, or a gateway controller connected to an amplifier. At 806, the gateway controller receives the pilot signals and measures characteristics of the received pilot signals, such as the levels, frequencies, tilt, etc. At 808, the gateway controller compares the measured characteristics with the pilot signal information. For example, if the pilot signal information states that a signal at X frequency is launched at Y level, and the node receives a signal at X frequency and measures it at Z level (which is less than Y), then the gateway controller can estimate loss between the first amplifier and the node, at frequency X, as Y−Z.

At 810, the gateway controller generates, based on the comparison of the measured characteristics with the pilot signal information, corrective instructions for the first amplifier. At 812, gateway controller transmits corrective instructions to the first amplifier, such as gain and tilt adjustments. Continuing the above example, the node may instruct the amplifier to launch X-frequency signals at Y+(Y−Z) level to offset the loss. At 814, the first amplifier may apply corrections in accordance with the corrective instructions, e.g., using AGC or ALSC. After applying corrections, the first amplifier may be compensating for the loss, downtilt, etc., between itself and the gateway controller. The method 800 may be repeated to verify that the corrections have the intended effect, and/or, to further adjust the parameters of the first amplifier to optimize performance.

The actions performed in the method 800 may be similarly performed with respect to a second, third, etc., amplifier. For example, once the first amplifier is appropriately compensating for the signal degradation between the first amplifier and the node, the second amplifier may send pilot signals upstream to the node. Now, any signal degradation (outside of any that could not be compensated for by the first amp) can be attributed to the cable between the second amplifier and the first amplifier. Instructions may then be sent to the second amplifier to compensate for that cable loss (etc.). In another example, a technician using a portable gateway controller may connect the portable gateway controller to the first amplifier, and instruct the second amplifier to send pilot signals upstream, whereby the portable gateway controller may receive and measure the pilot signals. In these ways, for example, a plurality of cascading amplifiers may be sequentially calibrated using upstream pilot signals.

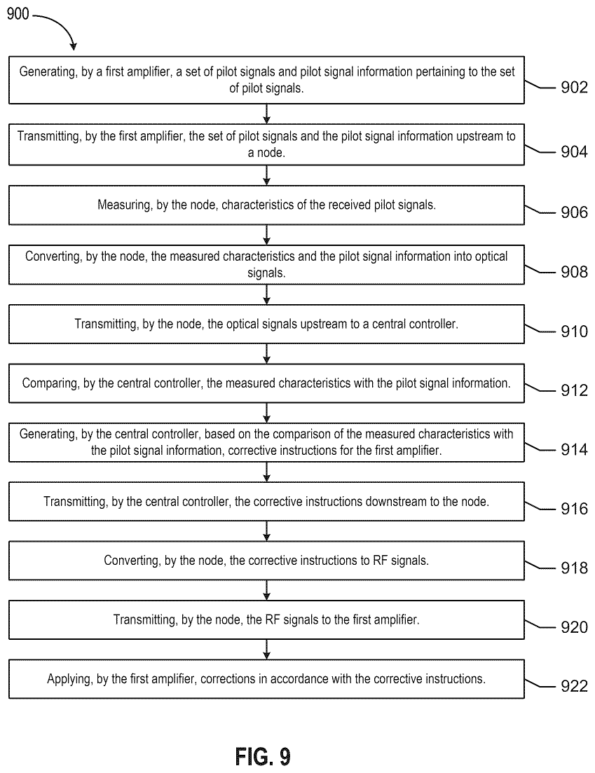

FIG. 9 is an exemplary flowchart of a method 900 of improving network performance. At 902, a first amplifier generates a set (i.e., one or more) of pilot signals and generates pilot signal information pertaining to the set of pilot signals. The pilot signal information may include, e.g., levels and frequencies of the pilot signals. At 904, the first amplifier transmits the set of pilot signals and the pilot signal information upstream to a node, e.g., node 211. At 906, the node receives and measures characteristics of the received pilot signals, such as the levels, frequencies, tilt, etc. At 908, the node converts the measured characteristics and the pilot signal information into optical signals, and at 910, the node transmits those optical signals upstream to a central controller, such as central controller 208. At 912, the central controller compares the measured characteristics with the pilot signal information, similar to step 808 of FIG. 8. At 914, the central controller generates, based on the comparison of the measured characteristics with the pilot signal information, corrective instructions for the first amplifier. At 916, the central controller transmits the corrective instructions downstream to the node. At 918, the node converts the corrective instructions to RF signals (such as FSK modulated signals) and at 920, the node transmits the RF signals to the first amplifier. At 922, the first amplifier applies corrections in accordance with the corrective instructions, e.g., using AGC or ALSC. After applying corrections, the first amplifier may be compensating for the loss, down tilt, etc., between itself and the node. The method 900 may be repeated to verify that the corrections have the intended effect, and/or, to further adjust the parameters of the first amplifier to optimize performance.

The actions performed in the method 900 may be similarly performed with respect to a second, third, etc., amplifier. For example, once the first amplifier is appropriately compensating for the signal degradation between the first amplifier and the node, the second amplifier may send pilot signals upstream to the central controller. Now, any signal degradation (outside of any that could not be compensated for by the first amp) can be attributed to the cable between the second amplifier and the first amplifier. Instructions may then be sent to the second amplifier to compensate for that cable loss (etc.). In this way, a plurality of cascading amplifiers may be sequentially calibrated using upstream pilot signals.

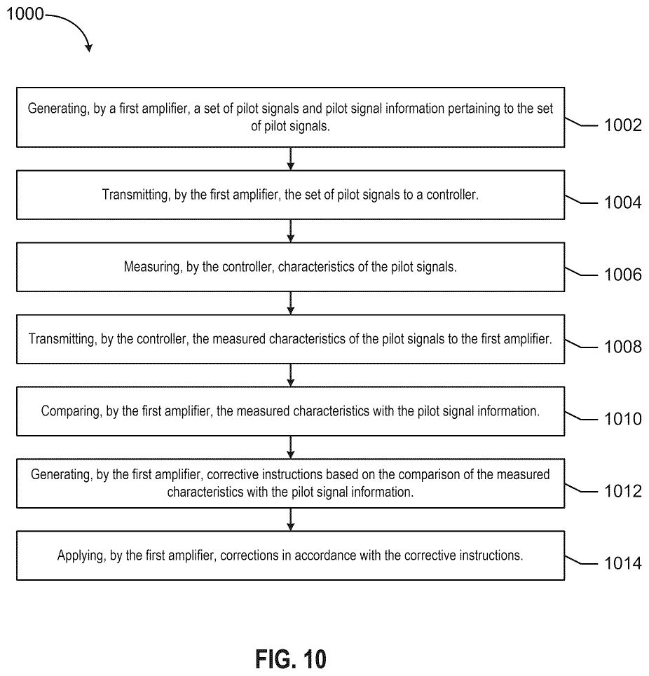

FIG. 10 is an exemplary flowchart of a method 1000 of improving network performance. At 1002, a first amplifier generates a set of pilot signals and pilot signal information pertaining to the set of pilot signals, including, e.g., pilot signal transmitted levels. At 1004, the first amplifier transmits the set of pilot signals upstream to a controller. The controller may be, e.g., a gateway controller, or an amplifier microcontroller 401, or a first or second mobile compute device 251, 261. At 1006, the controller measures characteristics of the pilot signals (e.g., received levels, tilt, etc.). At 1008, the controller transmits the measured characteristics of the pilot signals downstream to the first amplifier. At 1010, the first amplifier compares the measured characteristics with the pilot signal information. At 1012, the first amplifier generates corrective instructions to its transmission parameters based on the comparison of the measured characteristics with the pilot signal information in order to offset, e.g., cable loss and tilt between the first amplifier and an upstream node. At 1014, the first amplifier applies the corrective instructions. The method 1000 may be performed by subsequent amplifiers in the chain of amplifiers.

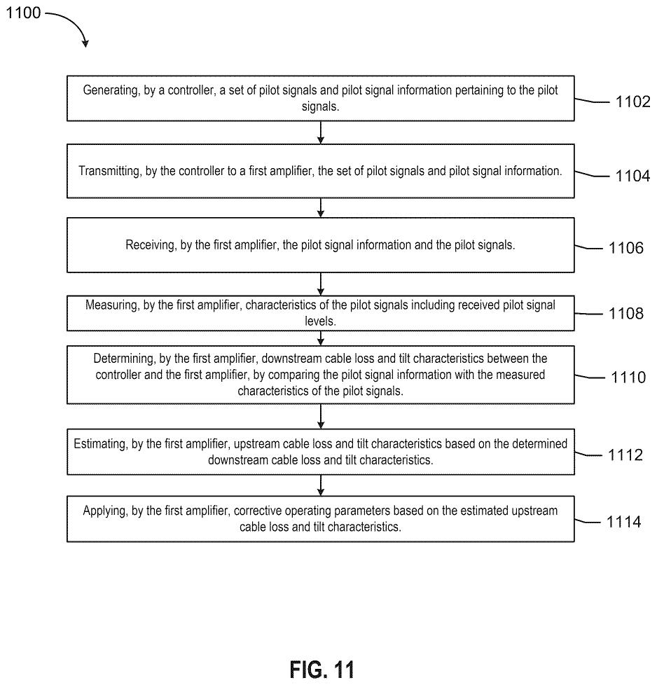

FIG. 11 is an exemplary flowchart of a method 1100 of improving network performance. At 1102, a gateway controller generates a set of downstream pilot signals, and pilot signal information pertaining to the pilot signals, including, e.g., pilot signal transmitted levels. At 1104, the gateway controller transmits the pilot signal information and the pilot signals to the first amplifier. These transmissions may occur simultaneously or sequentially. At 1106, the first amplifier receives the pilot signal information and the downstream pilot signals. At 1108, the first amplifier measures characteristics, such as received levels, tilt, noise, etc., of the downstream pilot signals. At 1110, the first amplifier determines downstream cable loss and tilt characteristics between the gateway controller and the first amplifier by comparing the pilot signal information with the measured characteristics of the downstream pilot signals. At 1112, the first amplifier estimates upstream cable loss and tilt characteristics based on the determined downstream cable loss and tilt characteristics between the gateway controller and the first amplifier. At 1114, the first amplifier applies corrective operating parameters based on the estimated upstream cable loss and tilt characteristics, which may partially or completely compensate for the loss and tilt characteristics between the gateway controller and the first amplifier.

Additional amplifiers in a cascade of amplifiers may be sent pilot signals and pilot signal information to enable them to estimate cable loss and tilt characteristics of the cable between themselves and the next upstream amplifier. In this way, a cascade of amplifiers may perform quasi-alignment, calibrating their upstream transmission parameters based on measured downstream signal degradation (e.g., loss and tilt).

In other embodiments, steps 1110 and 1112 may be performed by a controller other than the first amplifier, such as a gateway controller, central controller, mobile compute device, or another amplifier. In such cases, the first amplifier will transmit the measured characteristics of the pilot signals to the controller. The controller may generate corrective instructions and transmit them to the first amplifier, or may transmit the estimated upstream cable loss and tilt characteristics, which the first amplifier may use to generate corrective instructions.

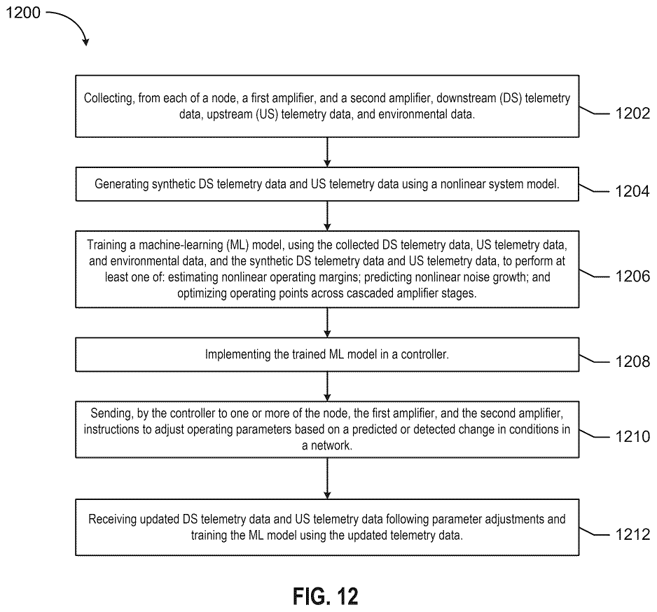

FIG. 12 is an exemplary flowchart of a method 1200 of training and using a machine-learning (ML) model to improve performance of a network. 1202 includes collecting, from each of a node, a first amplifier, and a second amplifier, downstream (DS) telemetry data, upstream (US) telemetry data, and environmental data. The DS telemetry data may include, for example: DS pilot tone levels (input and output); QAM/OFDM pre-channel power (PCP) levels (input and output); MER/CCN measurements; nonlinear noise growth indicators; and amplifier total composite power (TCP) measurements (input and output). The US telemetry data may include, for example: US pilot tone levels (input and output); TDMA/OFDMA burst levels; ingress/egress noise signatures; MER/CCN measurements; nonlinear noise growth indicators; peak-to-average power ratio (PAPR); and amplifier TCP measurements (input and output). Environmental data may include, for example: ambient temperature; amplifier temperature; estimated cable temperature, including electrical load effects; frequency-dependent pilot levels; DS tilt measurements; US tilt measurements; and historical day/night seasonal temperature cycles.

1204 includes generating synthetic DS and US telemetry data using a nonlinear system model. The nonlinear system model may include one or more of, for example: a hyperbolic tangent amplifier model; a polynomial series method; a nonlinear transform method; and a Price's theorem-based statistical distortion prediction. The nonlinear system model may be a physics-based model that captures higher-order distortion, nonlinear noise growth, and cascaded amplifier interactions under varying environmental and electrical load conditions.

The voltage levels in both downstream and upstream directions at the output of a nonlinear amplifier at cascade stage i of a total S cascade system, can be modeled as follows:

### Downstream:

$${v}_{out , i}^{F} ( t ) = {A}_{i}^{F} tanh ( {a}_{i}^{F} {v}_{in , i}^{F} ( t ) + {b}_{i}^{F} )$$

$${v}_{in , i}^{F} ( f ) = {v}_{out , i - 1}^{F} ( f ) {e}^{- {L}_{i} ( f , T , I ) / 20}$$

### Upstream:

$${v}_{out , i}^{R} ( t ) = {A}_{i}^{R} tanh ( {a}_{i}^{R} {v}_{in , i}^{R} ( t ) + {b}_{i}^{R} )$$

$${v}_{in , i - 1}^{R} ( f ) = {v}_{out , i}^{R} ( f ) {e}^{- {L}_{i} ( f , T , I ) / 20}$$

where attenuation is expressed in dB and converted to linear voltage scale, v_{in,i} (for simplicity we dropped superscripts F, and R that indicate the DS and US traffic directions) is a Gaussian multicarrier input voltage with variance

$${σ}_{i}^{2} ,$$

Aᵢ is a saturation scaling parameter, and aᵢ, and bᵢ are amplifier gain and bias parameters. The output power and nonlinear distortion are predicted using Price's theorem and Wiener-Hermite expansion, where the amplifier output voltage is expressed as v_{out,i}=Σₙc_{n,i}Hₙ(v_{in,i}/σᵢ), and the output power spectral density is computed as

$${S}_{out , i} ( f ) = {Σ}_{n} {\vert {c}_{n , i} \vert}^{2} {S}_{in , i}^{( * n )} ( f ) ,$$

with

$${S}_{in , i}^{\text{(*} n )}$$

the n-fold convolution of the input PSD. The modulation error ratio (MER) which is proportional to CCN is expressed as MER=P_{signal}/Pₙₒᵢₛₑ, where

$${P}_{signal} ∝ {\vert {c}_{1 , i} \vert}^{2} {σ}_{i}^{2} and {P}_{n o i s e} ∝ {Σ}_{n = 3 , 5} , … {\vert {c}_{n , i} \vert}^{2} {σ}_{i}^{2 n} + {σ}_{0}^{2} ,$$

and input variance

$${σ}_{i}^{2}$$

is modified according to frequency-dependent, temperature-dependent, and electrical load-dependent cable loss Lᵢ(f,T,I). Pₙₒᵢₛₑ is the non-linear signal-dependent noise, and

$${σ}_{0}^{2}$$

is the flat noise.

1206 includes training an ML model using the collected DS telemetry data, US telemetry data, and environmental data, and the synthetic DS telemetry data and US telemetry data, to perform at least one of estimating nonlinear operating margins; predicting nonlinear noise/distortion growth; and optimizing operating points across cascading amplifier stages. The ML model may estimate nonlinear noise/distortion growth as a function of input and output TCP and PCP; channel plan and spectrum loading profile; amplifier slope settings; amplifier attenuation/gain settings; ambient temperature; and cascade position. The ML model may estimate cable loss as a function of frequency, temperature, and electrical AC load by: calculating slope variation across the band; modeling electrical AC load-driven cable temperature variation; modeling temperature-driven attenuation; and predicting daytime and seasonal cable loss/tilt variation. The cable loss model may be fed into the nonlinear amplifier model so that: input power predictions include temperature effects; and compression margin estimation accounts for thermal loss drift. A linearity margin metric for each amplifier in both US and DS directions may be determined. Optimizing operating points across cascaded amplifier stages may include optimizing a multi-objective cost function including one or more of: CCN, MER, TCP, nonlinear noise and distortion, energy consumption, and thermal margin. For each cascade stage and direction:

$$x = {\{ {A}_{i , d} , {b}_{i , d} , {a}_{i , d} \}}_{i = 1 … S , d}$$

where d indicates the direction, and coefficients A_{i,d}, b_{a,d}, a_{i,d} include:
tilt settings
gain/attenuation settings
input back-off margins
   Amplifier parameters A_{i,d}, b_{i,d}, and a_{i,d} can be sequentially optimized for each cascade stage to maintain a predefined linearity margin, limit nonlinear distortion, and achieve upstream and downstream alignment while maintaining MER above a minimum threshold. Physics-informed machine learning is employed to adaptively predict and adjust amplifier parameters and account for dynamic variations in temperature, cable loss, and load, ensuring consistent PSD, tilt, and output power levels across the network.

Objective functions may be defined for the ML model, tailored for DS objectives and US objectives. DS objectives may include, for example: achieving target DS output levels; maintaining spectral flatness; minimizing distortion growth; minimizing nonlinear noise growth; predicting DS tilt drift due to temperature; adjusting slope proactively; preventing high-frequency compression during cold conditions; and preventing low-frequency under-drive during hot conditions. US objectives may include, for example: achieving predetermined US pilot level(s) at the node input; compensating for cable loss and tilt sequentially; minimizing ingress amplification; and controlling nonlinear noise growth. Constraints may be applied to the objective functions, including, e.g.: maintaining each amplifier below a compression threshold; maintaining minimum linearity margin; preventing intermodulation distortion beyond allowable limits; preventing cumulative cascade compression; estimating upstream return path attenuation drift; sequentially compensating each cascade segment; maintaining target node input level(s) despite thermal drift; and avoiding overdriving the first amplifier during cold periods. The ML model may determine optimized gain, slope, and equalization settings for each amplifier in the cascade sequentially, including: first amplifier compensation, and telemetry confirmation; second amplifier compensation and telemetry confirmation; etc. The ML model may predict future distortion and compression conditions based on, e.g.: temperature variations; daytime loading patterns; historical nonlinear behavior; and thermal-nonlinear coupled behavior. For example: increasing temperature causes increasing cable loss, which causes amplifier gain to increase, which creates a higher compression risk; decreasing temperature causes decreasing cable loss, which causes signal levels to rise, which creates higher compression risk. The ML model may predict the resulting nonlinear noise and distortion growth. Suppose one defines the distortion energy as:

$${D}_{i} = {\int }_{ℱ} {\sum }_{{n = 3 , 5 , …}^{}} {\vert {c}_{n , i} \vert}^{2} {S}_{in , i}^{( * n )} ( f ) df$$

The full optimization, assuming symmetrical amplifier response (bᵢ=0), can be found by minimizing each stage sequentially as:

$${min}_{\{ {a}_{i} , {A}_{i} \}} [ {w}_{1} {J}_{i , D S} + {w}_{2} {J}_{i , U S} + {w}_{3} {Σ}_{i} {D}_{i} ]$$

where w₁, w₂, and w₃ are weighting functions, J_{DS} and J_{US}DS, and US alignment cost functions subject to:

$${S}_{out , i} ( f ) = {\sum }_{n} {\vert {c}_{n , i} \vert}^{2} {S}_{in , i}^{( * n )} ( f )$$

and compression margin constraints, cable attenuation physics, Wiener-Hermite PSD model, and the like.

At 1208, the trained ML model can be implemented in a controller. The controller may be a central controller 208, a node gateway controller 213, a first compute device 251, and/or a second compute device 261, for example. 1210 includes sending, by the controller to one or more of the nodes, the first amplifier, and the second amplifier, instructions to adjust operating parameters based on a predicted or detected change in conditions in a network. In this way, the ML model may enable proactively adjusting amplifier parameters before distortion manifests, e.g., adjusting gain and slope before compression occurs due to a change in temperature. These adjustments may prevent nonlinear distortion propagation through cascade amplifier stages in both signal directions.

Training the ML model may include using self-adaptive closed-loop learning, such as: observing post-adjustment distortion and MER/CCN metrics; updating physics-informed ML models using real telemetry and synthetic nonlinear training data; and continuously refining compressing prediction accuracy, distortion growth modeling, and cascade stability margins. 1212 includes receiving updated DS telemetry data and US telemetry data following parameter adjustments and training the ML model using the updated telemetry data to, e.g., refine predictions, maintain operating margins, and prevent service degradation.

In all of the aforementioned methods, the actions described may not be the only actions performed, and the actions may be done in differing orders than in the examples shown.

It is to be noted that any one or more of the aspects and embodiments described herein can be conveniently implemented using one or more machines (e.g., one or more compute devices that are utilized as a user compute device for an electronic document, one or more server devices, such as a document server, etc.) programmed according to the teachings of the present specification. Appropriate software coding can readily be prepared by skilled programmers based on the teachings of the present disclosure. Aspects and implementations discussed above employing software and/or software modules can also include appropriate hardware for assisting in the implementation of the machine executable instructions of the software and/or software module.

Such software can be a computer program product that employs a machine-readable storage medium. A machine-readable storage medium can be any medium that is capable of storing and/or encoding a sequence of instructions for execution by a machine (e.g., a compute device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software can also include information (e.g., data) carried as a data signal on a data carrier, such as a carrier wave. For example, machine-executable information can be included as a data-carrying signal embodied in a data carrier in which the signal encodes a sequence of instruction, or portion thereof, for execution by a machine (e.g., a compute device) and any related information (e.g., data structures and data) that causes the machine to perform any one of the methodologies and/or embodiments described herein.

Examples of a compute device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a compute device can include and/or be included in a kiosk.

All combinations of the foregoing concepts and additional concepts discussed here within (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, multiple microprocessors, one or more microprocessors in conjunction with a DSP core or any other such configuration.

The term “memory” should be interpreted broadly to encompass any electronic component capable of storing electronic information. The term memory can refer to various types of processor-readable media such as random-access memory (RAM), read-only memory (ROM), non-volatile random-access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of:” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Less specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A network system comprising:
a headend;
a controller communicatively coupled to the headend via one or more communication links; and
a first amplifier, communicatively coupled to the controller, configured to:
generate a set of pilot signals having known transmit levels;
transmit the pilot signals upstream to the controller;
receive telemetric feedback data, based on the pilot signals, downstream via the controller; and
adjust operating parameters, based on the telemetric feedback data, to compensate for signal degradation occurring between the first amplifier and the controller.

2. The system of claim 1, further comprising a second amplifier, communicatively coupled to the first amplifier, configured to:
generate a set of pilot signals having known transmit levels;
transmit the pilot signals upstream to one or more of the first amplifier and the controller;
receive telemetric feedback data, based on the pilot signals, downstream via the first amplifier, and
adjust operating parameters, based on the telemetric feedback data, to compensate for signal degradation occurring between the first amplifier and the node.

3. The system of claim 1, wherein:
the first amplifier is configured to transmit pilot signal information, including the known transmit levels of the pilot signals, upstream to the controller; and
wherein the telemetric feedback data comprises instructions for the first amplifier to adjust its operating parameters to compensate for signal degradation occurring between the first amplifier and the node.

4. The system of claim 3, wherein the controller is configured to generate the instructions based on a comparison of the pilot signal information and the pilot signals.

5. The system of claim 1, wherein the telemetric feedback data includes received pilot signal levels, and wherein the first amplifier is configured to compare the received pilot signal levels with the known transmit pilot signal levels, estimate signal degradation occurring between the first amplifier and the node, generate corrective instructions based on the estimated signal degradation, and apply the corrective instructions to compensate for the estimated signal degradation.

6. The system of claim 1, wherein the telemetric feedback data is generated based on the output of a machine-learning model.

7. A method of improving performance of a network, comprising:
generating, by a first amplifier, a set of pilot signals and pilot signal information pertaining to the set of pilot signals, the pilot signal information including transmit levels of the pilot signals;
transmitting, by the first amplifier, the set of pilot signals and the pilot signal information to a gateway controller;
measuring, by the gateway controller, characteristics of the received pilot signals, the characteristics including received pilot signal levels;
comparing, by the gateway controller, the measured characteristics with the pilot signal information;
generating, by the gateway controller, based on the comparison of the measured characteristics with the pilot signal information, corrective instructions for the first amplifier;
transmitting, by the gateway controller, the corrective instructions to the first amplifier; and
applying, by the first amplifier, corrections in accordance with the corrective instructions.

8. The method of claim 7, further comprising:
generating, by a second amplifier, a second set of pilot signals and second pilot signal information pertaining to the second set of pilot signals, the second pilot signal information including transmit levels of the second pilot signals;
transmitting, by the second amplifier, the second set of pilot signals and the second pilot signal information upstream to the gateway controller;
measuring, by the gateway controller, characteristics of the received second pilot signals, the characteristics including received second pilot signal levels;
comparing, by the gateway controller, the measured characteristics of the second pilot signals with the second pilot signal information;
generating, by the gateway controller, based on the comparison of the measured characteristics of the second pilot signals with the second pilot signal information, corrective instructions for the second amplifier;
transmitting, by the gateway controller, the corrective instructions for the second amplifier downstream to the second amplifier; and
applying, by the second amplifier, corrections in accordance with the corrective instructions for the second amplifier.

9. The method of claim 7, wherein the gateway controller is co-located with a node.

10. A method of improving performance of a network, comprising:
generating, by a first amplifier, a set of pilot signals and pilot signal information pertaining to the set of pilot signals, the pilot signal information including transmit levels of the pilot signals;
transmitting, by the first amplifier, the set of pilot signals and the pilot signal information upstream to a node;
measuring, by the node, characteristics of the received pilot signals, the characteristics including received pilot signal levels;
comparing, by the node, the measured characteristics with the pilot signal information;
converting, by the node, the measured characteristics and the pilot signal information into optical signals;
transmitting, by the node, the optical signals upstream to a central controller;
comparing by the central controller, the measured characteristics with the pilot signal information;
generating, by the central controller, based on the comparison of the measured characteristics with the pilot signal information, corrective instructions for the first amplifier;
transmitting, by the central controller, the corrective instructions downstream to the node;
converting, by the node, the corrective instructions to RF signals;
transmitting, by the node, the RF signals to the first amplifier; and
applying, by the first amplifier, corrections in accordance with the corrective instructions.

11. The method of claim 10, further comprising:
generating, by a second amplifier, a second set of pilot signals and second pilot signal information pertaining to the second set of pilot signals, the second pilot signal information including transmit levels of the second pilot signals;
transmitting, by the second amplifier, the second set of pilot signals and the second pilot signal information upstream to the node;
measuring, by the node, characteristics of the received second pilot signals, the characteristics including received second pilot signal levels;
comparing, by the node, the measured characteristics of the received second pilot signals with the second pilot signal information;
converting, by the node, the measured characteristics of the received second pilot signals and the second pilot signal information into second optical signals;
transmitting, by the node, the second optical signals upstream to the central controller;
comparing by the central controller, the measured characteristics of the received second pilot signals with the second pilot signal information;
generating, by the central controller, based on the comparison of the measured characteristics of the received second pilot signals with the second pilot signal information, second corrective instructions for the second amplifier;
transmitting, by the central controller, the second corrective instructions downstream to the node;
converting, by the node, the second corrective instructions to second RF signals;
transmitting, by the node, the second RF signals to the second amplifier; and
applying, by the second amplifier, corrections in accordance with the second corrective instructions.

12. A method of improving performance of a network, comprising:
generating, by a first amplifier, a set of pilot signals and pilot signal information pertaining to the set of pilot signals, the pilot signal information including transmit levels of the pilot signals;
transmitting, by the first amplifier, the set of pilot signals upstream to a controller;
measuring, by the controller, characteristics of the received pilot signals, the characteristics including received pilot signal levels;
transmitting, by the controller, the measured characteristics downstream to the first amplifier;
comparing, by the first amplifier, the measured characteristics with the pilot signal information;
generating, by the first amplifier, corrective instructions based on the comparison of the measured characteristics with the pilot signal information; and
applying, by the first amplifier, corrections in accordance with the corrective instructions.

13. The method of claim 12, further comprising sending, by the first amplifier, the pilot signal information upstream to the controller.

14. The method of claim 12, further comprising:
generating, by a second amplifier, a second set of pilot signals and second pilot signal information pertaining to the second set of pilot signals, the second pilot signal information including transmit levels of the second pilot signals;
transmitting, by the second amplifier, the second set of pilot signals upstream to the controller;
measuring, by the controller, second characteristics of the received second pilot signals, the second characteristics including received second pilot signal levels;
transmitting, by the controller, the second measured characteristics downstream to the second amplifier;
comparing, by the second amplifier, the second measured characteristics with the second pilot signal information;
generating, by the second amplifier, second corrective instructions based on the comparison of the second measured characteristics with the second pilot signal information; and
applying, by the second amplifier, corrections in accordance with the second corrective instructions.

15. A method of improving performance of a network, comprising:
generating, by a controller, a set of pilot signals and pilot signal information pertaining to the pilot signals;
transmitting, by the controller to a downstream first amplifier, the set of pilot signals and pilot signal information;
receiving, by the first amplifier, the pilot signal information and the pilot signals;
measuring, by the first amplifier, characteristics of the pilot signals, including received pilot signal levels;
determining, by one or more of the first amplifier, the controller, a gateway controller, a central controller, and a mobile compute device, downstream cable loss and tilt characteristics between the controller and the first amplifier, by comparing the pilot signal information with the measured characteristics of the pilot signals;
estimating, by one or more of the first amplifier, the controller, the gateway controller, the central controller, and the mobile compute device, upstream cable loss and tilt characteristics based on the determined downstream cable loss and tilt characteristics; and
applying, by the first amplifier, corrective operating parameters based on the estimated upstream cable loss and tilt characteristics.

16. The method of claim 15, wherein the controller is a gateway controller.

17. The method of claim 15, wherein the controller is an amplifier upstream of the first amplifier.

18. The method of claim 15, further comprising:
generating, by the controller, a second set of pilot signals and second pilot signal information pertaining to the second pilot signals;
transmitting, by the controller to a downstream second amplifier, the second set of pilot signals and second pilot signal information;
receiving, by the second amplifier, the second pilot signal information and the second pilot signals;
measuring, by the second amplifier, second characteristics of the second pilot signals, including received second pilot signal levels;
determining, by one or more of the second amplifier, the controller, the gateway controller, the central controller, and the mobile compute device, second downstream cable loss and tilt characteristics between the controller and the second amplifier, by comparing the second pilot signal information with the second measured characteristics of the second pilot signals;
estimating, by one or more of the second amplifier, the controller, the gateway controller, the central controller, and the mobile compute device, second upstream cable loss and tilt characteristics based on the determined second downstream cable loss and tilt characteristics; and
applying, by the second amplifier, corrective operating parameters based on the estimated second upstream cable loss and tilt characteristics.

19. A method of improving performance of a network, comprising:
collecting, from each of a node, a first amplifier, and a second amplifier, downstream (DS) telemetry data, upstream (US) telemetry data, and environmental data;
generating synthetic DS telemetry data and US telemetry data using a nonlinear system model;
training a machine-learning (ML) model, using the DS telemetry data, US telemetry data, and environmental data, and the synthetic DS telemetry data and US telemetry data, to perform at least one of: estimating nonlinear operating margins; predicting nonlinear noise growth; and optimizing operating points across cascaded amplifier stages;
implementing the trained ML model in a controller;
sending, by the controller to one or more of the node, the first amplifier, and the second amplifier, instructions to adjust operating parameters based on a predicted or detected change in conditions in the network;
receiving updated DS and US telemetry data following the parameter adjustments and training the ML model using the updated telemetry data.

20. The method of claim 19, wherein the controller is a central controller, a node, or a mobile compute device.
